(19) United States
(12) Patent Application Publication
(10) Pub. No.: US 2025/0376096 A1
(43) Pub. Date: Dec. 11, 2025

(54) EXTRUDED PLASTIC MESH, SEAT ASSEMBLY, CUSHION AND/OR METHOD OF FORMING

(71) Applicant: LEAR CORPORATION, Southfield, MI (US)

(72) Inventors: Joseph A. HIMMEL, IV, Southfield, MI (US); Michelle A. BRUDZYNSKY, Farmington Hills, MI (US); Ibrahim VALENZUELA, Novi, MI (US); Haifeng LIU, Southfield, MI (US); Kevin M. GEISLER, Southfield, MI (US); Curtis HUDSON, Macomb, MI (US); Christopher D. JOHNSON, Southfield, MI (US); Lisa SWIKOSKI, West Bloomfield, MI (US); Samuel BLAIR, Troy, MI (US); Ashley BAISCH, Washington Twp., MI (US); David ABDELLA, Royal Oak, MI (US); Joshua HALLOCK, Warren, MI (US); David KAZYAK, Brighton, MI (US); William WEBSTER, Millington, MI (US)

(73) Assignee: LEAR CORPORATION, Southfield, MI (US)

(21) Appl. No.: 18/874,757

(22) PCT Filed: Jun. 12, 2023
(86) PCT No.: PCT/US2023/025075

§ 371 Date: Dec. 13, 2024

Related U.S. Application Data
(60) Provisional application No. 63/351,902, filed on Jun. 14, 2022.
(60) Provisional application No. 63/355,158, filed on Jun. 24, 2022.
(60) Provisional application No. 63/355,700, filed on Jun. 27, 2022.
(60) Provisional application No. 63/355,754, filed on Jun. 27, 2022.
(60) Provisional application No. 63/355,793, filed on Jun. 27, 2022.
(60) Provisional application No. 63/356,555, filed on Jun. 29, 2022.
(60) Provisional application No. 63/357,056, filed on Jun. 30, 2022.

(30) Foreign Application Priority Data
Apr. 25, 2023 (DK) PA202370197

(51) Int. Cl. B60N 2/70; B32B 5/02; B32B 5/26; B60N 2/58; B60N 2/66

(52) U.S. Cl. CPC B60N 2/7017; B32B 5/028; B32B 5/26; B60N 2/5883; B60N 2/66; B32B 2250/20; B32B 2262/0253; B32B 2605/003

(57) ABSTRACT

A seat support is provided with a plurality of flat layers to mount to a seat frame and to support an occupant upon the seat frame. The plurality of flat layers is stacked upon one another, and each of the plurality of stacked layers has a varying density. A seat support is provided with one or a plurality of layers of an extruded thermoplastic resin mesh to mount to a seat frame and to support an occupant upon the seat frame. The plurality of layers may be stacked upon each other.

### CROSS-REFERENCE TO RELATED APPLICATIONS

This application claims priority of: U.S. application Ser. No. 63/351,902 filed Jun. 14, 2022; U.S. application Ser. No. 63/356,555 filed Jun. 29, 2022; U.S. application Ser. No. 63/355,754 filed Jun. 27, 2022; U.S. application Ser. No. 63/355,793 filed Jun. 27, 2022; U.S. application Ser. No. 63/355,700 filed Jun. 27, 2022; U.S. application Ser. No. 63/357,056 filed Jun. 30, 2022; U.S. application Ser. No. 63/355,158 filed Jun. 24, 2022; and Denmark application Serial No. PA 2023 70197 filed Apr. 25, 2023; the disclosures of which are hereby incorporated in their entirety by reference herein.

### TECHNICAL FIELD

Various embodiments relate to vehicle seat components, seat cushions, seat assemblies, methods for manufacturing seat cushions, and methods for designing seat cushions.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 is a perspective section view of a seat assembly according to some embodiments;

FIG. 2 is an exploded perspective view of a plurality of layers of a seat assembly according to some embodiments;

FIG. 3 is a side section view of a seat assembly according to some embodiments;

FIG. 3B illustrates a method in accordance with some embodiments;

FIG. 4 is a front perspective view of a seat assembly according to some embodiments;

FIG. 5 is a front perspective view of a cushion of the seat assembly of FIG. 4;

FIG. 6 is a side elevation view of the cushion of FIG. 5;

FIG. 7 is a front elevation schematic view of the cushion of FIG. 5;

FIG. 8 is a front perspective view of a portion of the cushion of FIG. 5;

FIG. 9 is a side elevation view of a portion of a cushion according to some embodiments, illustrated in a first position;

FIG. 10 is another side elevation view of the portion of the cushion of FIG. 9, illustrated in a second position;

FIG. 11 is a front view of a cushion according to some embodiments, illustrated partially disassembled;

FIG. 12 is a rear view of the cushion of FIG. 11;

FIG. 13 is another rear view of the cushion of FIG. 11, illustrated after an intermediate assembly step;

FIG. 14 is another rear view of the cushion of FIG. 11, illustrated after another assembly step;

FIG. 15 is a front view of the cushion of FIG. 11, illustrated after the assembly steps from FIGS. 11-14;

FIG. 16 is a side elevation view of a cushion according to some embodiments;

FIG. 16B illustrates a method in accordance with some embodiments;

FIG. 16C illustrates a method in accordance with some embodiments;

FIG. 16D illustrates a method in accordance with some embodiments;

FIG. 17 is a perspective view of a vehicle seat;

FIG. 18A is a front view of a vehicle seat cushion component with plastic mesh side bolsters;

FIG. 18B is a front view of a vehicle seat cushion component with plastic mesh side bolsters;

FIG. 19A is a front view of a vehicle seat cushion component with plastic mesh side bolsters and one or more skin layers;

FIG. 19B is a front view of a vehicle seat cushion component with plastic mesh side bolsters and one or more skin layers;

FIG. 20 is a perspective view of a vehicle seat that incorporates a pair of bolster assemblies sewn to a trim cover;

FIG. 21A is a top view of a vehicle seat component including a pair of bolster assemblies sewn to a trim cover;

FIG. 21B is a cross-sectional view of a vehicle seat component including a pair of bolster assemblies sewn to a trim cover;

FIG. 22 is a perspective view of a vehicle seat;

FIG. 23A is a front view of a vehicle seat cushion component with foamed side bolsters;

FIG. 23B is a front view of a vehicle seat cushion component with foamed side bolsters;

FIG. 24A is a front view of a vehicle seat cushion component with foamed side bolsters and one or more skin layers;

FIG. 24B is a front view of a vehicle seat cushion component with foamed side bolsters and one or more skin layers;

FIG. 25 is a perspective view of a seat assembly according to some embodiments;

FIG. 26 is a partial perspective view of a foamless cushion of the seat assembly of FIG. 25;

FIG. 27 is a partial top plan view of a retainer component attached to the cushion of FIG. 25 and other seating components;

FIG. 27B illustrates a method in accordance with some embodiments;

FIG. 28 illustrates a perspective view of a seat assembly according to some embodiments;

FIG. 29 illustrates a partial view of a section of a cushion according to some embodiments and for use with the seat assembly of FIG. 28;

FIG. 30 illustrates a schematic view of a manufacturing process for the cushion of FIG. 29 according to some embodiments;

FIG. 31 illustrates a top view of an extrusion direction for use with the manufacturing process of FIG. 29;

FIG. 32 illustrates a partial side schematic view of a cushion formed using the die of FIG. 31 in a first configuration according to some embodiments and for use with the seat assembly of FIG. 28;

FIG. 33 illustrates a partial side schematic view of the cushion of FIG. 32 in a second configuration;

FIG. 34 illustrates a partial side schematic view of the cushion of FIG. 32 with inserts;

FIG. 35 illustrates a top view of another part or example for use with the manufacturing process of FIG. 29;

FIG. 36 illustrates a partial side schematic view of a cushion formed using the die of FIG. 35 in a first configuration according to some embodiments and for use with the seat assembly of FIG. 28;

FIG. 37 illustrates a partial side schematic view of the cushion of FIG. 36 in a second configuration; and

FIG. 38 illustrates a method in accordance with some embodiments.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first surface could be termed a second surface, and, similarly, a second surface could be termed a first surface, without departing from the scope of the various described embodiments. The first surface and the second surface are both surfaces, but they are not the same surface.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items. For example, the term “and/or” means that either all or only one of the elements of said group may be present. For example. “A and/or B” shall mean “only A, or only B, or both A and B”. In the case of “only A”, the term also covers the possibility that B is absent, i.e., “only A, but not B”.

It will be further understood that the terms “includes,” “including,” “comprises.” and/or “comprising.” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting.” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event].” depending on the context.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer.” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e., the range from 95 to 105. Generally, when the term “about” is used, it can be expected that similar results or effects according to the invention can be obtained within a range of +/−5% of the indicated value.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

Seat assemblies, and vehicle seat assemblies are designed and manufactured in light of various specifications, including support, comfort, performance, heating, ventilation, cooling, adjustability, and the like. Seat assemblies are often provided with a frame, and various layers of foam with varying densities to accommodate an applicable load distribution across the seat assembly.

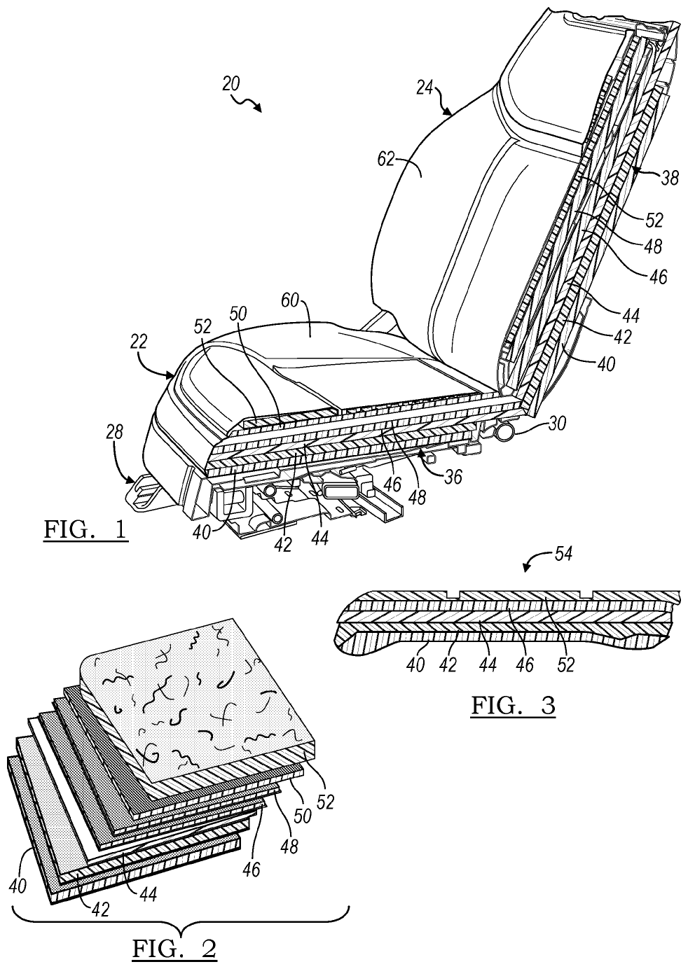

FIG. 1 illustrates a seat assembly 20 according to an embodiment. The seat assembly 20 is depicted as a vehicle seat, which may be employed as a seat assembly in a land vehicle, an aircraft, a watercraft, or the like. The seat assembly 20 may be employed within any row within the vehicle. Alternatively, the seat assembly 20 may also be employed as an office chair, or any individual chair. The seat assembly 20 omits traditional foam, in order to improve support and comfort, while reducing costs, material and size. The seat assembly 20 may also employ recycled materials, which are manufactured for further recycling at the end of use of the seat assembly 20.

The seat assembly 20 includes a seat bottom 22, which is sized to receive a seated occupant to support a pelvis and thighs of the occupant. The seat assembly 20 also includes a seat back 24 sized to extend upright from the seat bottom 22 to support a back of the occupant. A head restraint may also be supported upon and above the seat back 24 to support a head of the occupant. The seat bottom 22 is adapted to be supported by an underlying support surface. For the depicted embodiment, the seat assembly 20 includes a pair of rails 28 for mounting the seat bottom 22 to a vehicle floor for fore and aft adjustment relative to the vehicle floor. The seat back 24 may also be adjustable for recline relative to the seat bottom 22. The head restraint may also be adjustable in height, tilt, and fore/aft directions. Other adjustments may be provided, as are known in the art.

The seat bottom 22 includes a frame 30 for providing rigid structural support to the seat bottom 22. The seat back 24 may also include a frame connected to the seat bottom frame 30 to extend upright from the seat bottom 22, and to provide rigid structural support to the seat back 24. The frame 30 may be formed from a stamped steel alloy, a fiber reinforced polymer, or any suitable structural material.

Conventional seating assemblies include a plurality of foam layers to collectively provide cushioning upon the frames 30. The foam layers vary in density to provide compliant support to the occupant while distributing forces from the occupant to the frames 30. The foam layers also provide comfort to the occupant. The foam layers are often molded, thereby requiring dedicated tooling for each foam layer of each seating assembly.

The seat assembly 20 is formed without foam to improve comfort, performance, compactness, and recycling, while reducing manufacturing tooling costs. For example, the seat assembly 20 includes a seat bottom support 36, which provides the seat bottom cushion for the seat bottom 22. The seat bottom support 36 is formed from a plurality of stacked layers of a non-foam material. The seat back 24 includes a seat back support 38 that is also formed of the non-foam stacked layers. Likewise, the head restraint may also be provided with a head restraint support formed from the non-foam stacked layers.

FIG. 1 illustrates a plurality of the stacked layers 40, 42, 44, 46, 48, 50, 52 that are employed to construct the seat bottom support 36, the seat back support 38 and the head restraint support. Each of the stacked layers 40, 42, 44, 46, 48, 50, 52 may have a varying material density. The stacked layers 40, 42, 44, 46, 48, 50, 52 may have a sequentially decreasing material density and firmness from a base layer 40, to intermediate layers 42, 44, 46, 48, 50, and to a comfort layer 52. The stacked layers 40, 42, 44, 46, 48, 50, 52 provide a transition in density and firmness from comfort support at an occupant contact surface at the comfort layer 52 to structural support at the base layer 40.

For the depicted embodiment, the base layer 40 may be formed from a high-density material such as an elastomer, ethylene propylene diene monomer rubber, a thermoplastic polyurethane, or an expanded polyvinylchloride. The base layer 40 may provide a substrate or shell for the intermediate layers 42, 44, 46, 48, 50, and the comfort layer 52. The base layer 40 may be installed directly to the frame 30. The base layer 40 may have a suitable thickness, such as two millimeters or less.

The stacked layers 40, 42, 44, 46, 48, 50, 52 are illustrated as a plurality of sheets in FIG. 2. The sheets 40, 42, 44, 46, 48, 50, 52 are each unrolled from a roll of material. The sheets 40, 42, 44, 46, 48, 50, 52 are unrolled flat. Flatness is generally planar within manufacturing tolerances. Each of the rolls of material may be material rolls that are readily available in the market, such as materials employed in vehicle interiors, flooring, acoustics, and the like. Examples of these materials include rubber, carpet, needled cotton shoddy, polyethylene terephthalate, linear low-density polyethylene, polypropylene, and the like. By utilizing existing materials, material and manufacturing costs are reduced in comparison to molding a foam cushion from dedicated tooling. The materials may also be formed from a recycled material to reduce material costs, and to reduce waste. According to another embodiment, one or more of the layers 40, 42, 44, 46, 48, 50, 52 may be formed from extruded thermoplastic resin mesh as described in subsequent embodiments.

After the layers 40, 42, 44, 46, 48, 50, 52 are unrolled as sheets 40, 42, 44, 46, 48, 50, 52, then the sheets 40, 42, 44, 46, 48, 50, 52 are die cut into shape as seat support layers 40, 42, 44, 46, 48, 50, 52 to collectively provide the contour of the seat bottom 22. Then the seat support layers 40, 42, 44, 46, 48, 50, 52 are stacked and connected or bonded together. The seat support layers 40, 42, 44, 46, 48, 50, 52 may be welded, sewn, fastened, adhered, or otherwise connected to the sequentially adjacent seat support layers 40, 42, 44, 46, 48, 50, 52. Alternatively, the sheets 40, 42, 44, 46, 48, 50, 52 may be stacked, or may be stacked and bonded, before the cutting operation. The cutting operation may be performed by one or more dies. The tooling costs for cutting dies provide a reduction in capital costs in comparison to dedicated molds. Alternatively, robotic laser cutting, or other flexible automation may be employed to reduce tooling costs, which may be programmed to cut various seating arrangements.

The layers 40, 42, 44, 46, 48, 50, 52 may be customizable. The layers 40, 42, 44, 46, 48, 50, 52 may each be formed from a specific firmness and thickness, so that varying combinations of the layers 40, 42, 44, 46, 48, 50, 52 can be employed to optimize a specified support and comfort curve profile for a variety of seats. Comfort curve profiles are developed by estimated pressure distributions across the seat assembly 20 based on set design characteristics for occupants based on predicted heights, weights, and other data for a target range of occupants. Seat assemblies 20 that utilize stacked layers 40, 42, 44, 46, 48, 50, 52 instead of polyurethane foam and that are designed to provide the same static comfort reduce weight in comparison to the same seat assembly made with foam. Additionally, the stacked layers 40, 42, 44, 46, 48, 50, 52 permit more design flexibility to reduce pressure in peak areas in the seat assembly 20.

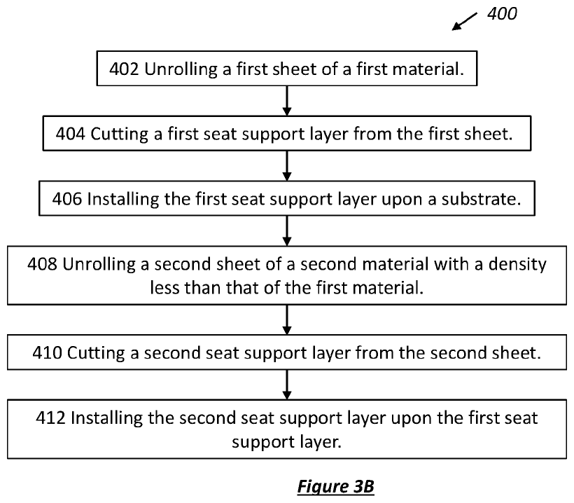

FIG. 3 illustrates a seat support 54 in accordance with some embodiments. The shell or substrate 40 may be formed with a contour instead of from a flat sheet 40. The intermediate layers 42, 44, 46, and the comfort layer 52 are then installed upon the substrate 40.

Referring again to FIG. 1, once the stacked layers 40, 42, 44, 46, 48, 50, 52 are assembled, the seat supports 36, 38, are installed in the seat assembly 20. A trim cover 60, 62 is provided over each seat support 36, 38 to contain and conceal the seat supports 36, 38.

By eliminating foam from the seat assembly 20, molds and dies can be eliminated thereby reducing tooling costs. The flexibility of die cutting, laser cutting, or other flexible automation lowers maintenance costs and increases part quality. The recyclability of the materials reduces scrap waste. Additionally, chemical usage is reduced in the manufacturing process.

The seat assembly 20 is lighter than a comparable seat fabricated with foam cushioning. The seat assembly 20 is also more compact in size, such as thirty-five to forty millimeters in depth, while providing similar or improved comfort. Targeted comfort layers are provided and can be easily redesigned for future models or options without additional tooling costs.

FIG. 3B illustrates a method 400 in accordance with some embodiments. Method 400 is used for manufacturing a seat assembly (e.g., seat assembly 20, 120, 210, 310, 410, 520, 620), which may be a vehicle seat, office chair, individual chair, and/or the like. In various examples, method 400 may have greater or fewer steps than described below, and various steps may be performed in another order, sequentially, or simultaneously. The method 400 may be a method of manufacturing a product, which may be a vehicle seat, an office chair, an individual chair, a cushion, a seat support, a seat bottom cushion, a seat back cushion, a head restraint or the like.

Method 400 includes unrolling (402) a first sheet, which may be generally planar within manufacturing tolerances, of a first material, which may be with or without foam, sheets of rubber, carpet, needled cotton shoddy, polyethylene terephthalate, polypropylene, ethylene propylene diene monomer rubber, a thermoplastic polyurethane, an expanded polyvinylchloride, recycled material, and/or each unrolled from a roll of material. Each of the rolls of material may be material rolls that are readily available in the market, such as materials employed in vehicle interiors, flooring, acoustics, and the like. Method 400 includes cutting (404), which may be die cutting, robotic laser cutting, waterjet cutting, laser cutting, or other flexible automation, of a first seat support layer (e.g., intermediate layer 42) for a seat bottom, a seat back, a head restraint, or the like, for example, from the first sheet and installing (406) the first seat support layer (e.g., intermediate layer 42) upon a substrate (e.g., 40), which may be a high-density material such as an elastomer, ethylene propylene diene monomer rubber, a thermoplastic polyurethane, and/or an expanded polyvinylchloride. The base layer may provide a substrate or shell for the intermediate layers, and the comfort layer may be formed with a contour instead of from a flat sheet. Method 400 includes unrolling (408) a second sheet, which may be generally planar within manufacturing tolerance, of a second material with a density less than that of the first material, which may provide a transition in density and firmness from comfort support at an occupant contact surface at the comfort layer to structural support at the base layer. The second material may be with or without foam, sheets of rubber, carpet, needled cotton shoddy, polyethylene terephthalate, polypropylene, ethylene propylene diene monomer rubber, a thermoplastic polyurethane, an expanded polyvinylchloride, recycled material, and/or each unrolled from a roll of material. Each of the rolls of material may be material rolls that are readily available in the market, such as materials employed in vehicle interiors, flooring, acoustics, and/or the like. Method 400 includes cutting (410), which may be die cutting, robotic laser cutting, waterjet cutting, laser cutting, and/or other flexible automation, of a second seat support layer (e.g., intermediate layer 44), for a seat bottom, a seat back, a head restraint, and/or the like, for example, from the second sheet and installing (412) the second seat support layer (e.g., intermediate layer 44) upon the first seat support layer (e.g., intermediate layer 42).

In some embodiments, method 400 includes unrolling a third sheet, which may be generally planar within manufacturing tolerances, of a third material with a density less than that of the second material, which may provide a transition in density and firmness from comfort support at an occupant contact surface at the comfort layer to structural support at the base layer. The third material may be with or without foam, sheets of rubber, carpet, needled cotton shoddy, polyethylene terephthalate, polypropylene, ethylene propylene diene monomer rubber, a thermoplastic polyurethane, an expanded polyvinylchloride, recycled material, and/or each unrolled from a roll of material. Each of the rolls of material may be material rolls that are readily available in the market, such as materials employed in vehicle interiors, flooring, acoustics, and/or the like. Method 400 includes cutting, which may be die cutting, robotic laser cutting, waterjet cutting, laser cutting, and/or other flexible automation, of a third seat support layer (e.g., intermediate layer 46) from the third sheet and installing the third seat support layer (e.g., intermediate layer 46) upon the second seat support layer (e.g., intermediate layer 44).

In some embodiments, method 400 includes bonding the second seat support layer (e.g., intermediate layer 44) to the first seat support layer (e.g., intermediate layer 42). The bonding may be provided with a retention clip having an end embedded in the foam and a retention clip end attached to the plastic mesh base, hook and loop connector strips, hook layers, loop layers, adhesives, hog rings, single- or double-sided retention clips, welding, sewn, fastened, adhered, heat staked, and/or otherwise retained.

A seat assembly is described (e.g., seat assembly 20), which may be a vehicle seat, office chair, individual chair, and/or the like. In some embodiments, the seat assembly (e.g., 20, 120, 210, 310, 410, 520, 620) is manufactured using method 400.

A seat support (e.g., seat supports 36, 38, and/or 54) is described, which may be a seat bottom cushion, a seat back cushion, a head restraint, a headrest, a bolster, a region, a portion, and/or the like. The seat support (e.g., seat supports 36, 38, and/or 54) includes a plurality of flat layers (e.g., intermediate layers 42-50), which may be generally planar within manufacturing tolerances, and which may be with or without foam, sheets of rubber, carpet, needled cotton shoddy, polyethylene terephthalate, polypropylene, ethylene propylene diene monomer rubber, a thermoplastic polyurethane, an expanded polyvinylchloride, recycled material, and/or each unrolled from a roll of material. Each of the rolls of material may be material rolls that are readily available in the market, such as materials employed in vehicle interiors, flooring, acoustics, and/or the like. The plurality of flat layers is to mount to a seat frame, which may be a stamped steel alloy, a fiber reinforced polymer, or any suitable structural material, wire suspension mats, a substrate, and/or a panel, and to support an occupant upon the seat frame. The plurality of flat layers (e.g., intermediate layers 42-50) is stacked upon one another (e.g., as in FIGS. 2-3), and each of the plurality of stacked layers has a varying density, which may provide a transition in density and firmness from comfort support at an occupant contact surface at the comfort layer to structural support at the base layer.

In some embodiments, the plurality of stacked layers (e.g., intermediate layers 42-50) varies in sequentially increasing density from an occupant support surface (e.g., layer 52) to a base layer (e.g., layer 42), which may provide a transition in density and firmness from comfort support at an occupant contact surface at the comfort layer to structural support at the base layer, which may include a high-density material such as an elastomer, ethylene propylene diene monomer rubber, a thermoplastic polyurethane, and/or an expanded polyvinylchloride. The base layer may provide a substrate or shell for the intermediate layers, and the comfort layer.

In some embodiments, the plurality of stacked layers (e.g., intermediate layers 42-50) varies in sequentially increasing firmness from an occupant support surface (e.g., layer 52) to a base layer (e.g., layer 42), which may provide a transition in density and firmness from comfort support at an occupant contact surface at the comfort layer to structural support at the base layer, which may include a high-density material such as an elastomer, ethylene propylene diene monomer rubber, a thermoplastic polyurethane, and/or an expanded polyvinylchloride. The base layer may provide a substrate or shell for the intermediate layers, and the comfort layer.

In some embodiments, the plurality of stacked layers (e.g., intermediate layers 42-50) is connected together, which may be with a retention clip having an end embedded in the layers, and a retention clip end attached to the plastic mesh base, hook and loop connector strips, hook layers, loop layers, adhesives, hog rings, single- or double-sided retention clips, bonding, welding, sewn, fastened, adhered, heat staked, and/or retained.

In some embodiments, each sequential pair (e.g., layers 42 and 44; layers 46 and 48) of the plurality of stacked layers (e.g., intermediate layers 42-50) are bonded together, which may be with a retention clip having an end embedded in the layers, and a retention clip end attached to the plastic mesh base, hook and loop connector strips, hook layers, loop layers, adhesives, hog rings, single- or double-sided retention clips, welding, sewn, fastened, adhered, heat staked, and/or retained.

In some embodiments, each sequential pair (e.g., layers 42 and 44; layers 46 and 48) of the plurality of stacked layers (e.g., intermediate layers 42-50) are welded, sewn, fastened, or adhered together.

In some embodiments, the plurality of stacked layers (e.g., intermediate layers 42-50) further comprises rubber, carpet, needled cotton shoddy, polyethylene terephthalate, or polypropylene.

In some embodiments, the plurality of stacked layers (e.g., layers 40-50) further comprises a base layer (e.g., layer 40) adapted to mount to the seat frame, wherein the base layer (e.g., layer 40) is formed from a denser material than the other layers of the plurality of stacked layers, which may be a high-density material such as an elastomer, ethylene propylene diene monomer rubber, a thermoplastic polyurethane, and/or an expanded polyvinylchloride. The base layer may provide a substrate or shell for the intermediate layers, and/or the comfort layer.

In some embodiments, the base layer (e.g., layer 40) is formed from an elastomeric material, such as a high-density material such as an elastomer, ethylene propylene diene monomer rubber, a thermoplastic polyurethane, and/or an expanded polyvinylchloride. The base layer may provide a substrate or shell for the intermediate layers, and the comfort layer.

In some embodiments, the base layer (e.g., layer 40) is formed from an ethylene propylene diene monomer rubber, a thermoplastic polyurethane, or an expanded polyvinylchloride. The base layer may provide a substrate or shell for the intermediate layers, and the comfort layer.

In some embodiments, the base layer (e.g., layer 40) has a thickness of two millimeters or less.

The technique described above with respect to method 400 is optionally combined with one or more elements of the methods described below. For example, this method can be used in conjunction with one or more methods 1600, 1650, 1680, 2700, 3800.

A seat assembly is described (e.g., seat assembly 20), which may be a vehicle seat, office chair, individual chair, and/or the like. In some embodiments, the seat assembly (e.g., 20, 120, 210, 310, 410, 520, 620) is manufactured using method 400. The seat assembly comprises a substrate (e.g., layer 40) adapted to be mounted to a seat frame and a seat support (e.g., seat supports 36, 38, and/or 54) is stacked upon the substrate.

In some embodiments, the substrate (e.g., layer 40), which may be a high-density material such as an elastomer, ethylene propylene diene monomer rubber, a thermoplastic polyurethane, and/or an expanded polyvinylchloride. The base layer may provide a substrate or shell for the intermediate layers, and the comfort layer may be formed with a contour instead of from a flat sheet. In some embodiments, the substrate is formed from an elastomeric material, such as a high-density material such as an elastomer, ethylene propylene diene monomer rubber, a thermoplastic polyurethane, and/or an expanded polyvinylchloride. The base layer may provide a substrate or shell for the intermediate layers, and the comfort layer.

In some embodiments, the substrate (e.g., layer 40) is formed from an ethylene propylene diene monomer rubber, a thermoplastic polyurethane, or an expanded polyvinylchloride.

In some embodiments, the seat assembly includes a seat frame, which may be a stamped steel alloy, a fiber reinforced polymer, or any suitable structural material, wire suspension mats, a substrate, and/or a panel, and the substrate (e.g., layer 40) is attached to the seat frame.

A seat support (e.g., seat supports 36, 38, and/or 54) is described, which may be a seat bottom cushion, a seat back cushion, a head restraint, a headrest, a bolster, a region, a portion, and/or the like. The seat support (e.g., seat supports 36, 38, and/or 54) comprises a plurality of flat layers (e.g., layers 40-50), which may be generally planar within manufacturing tolerances, and which may be with or without foam, sheets of rubber, carpet, needled cotton shoddy, polyethylene terephthalate, polypropylene, ethylene propylene diene monomer rubber, a thermoplastic polyurethane, an expanded polyvinylchloride, recycled material, and/or each unrolled from a roll of material. Each of the rolls of material may be material rolls that are readily available in the market, such as materials employed in vehicle interiors, flooring, acoustics, and/or the like. The plurality of flat layers is to mount to a seat frame, which may be a stamped steel alloy, a fiber reinforced polymer, or any suitable structural material, wire suspension mats, a substrate, and/or a panel, and to support an occupant upon the seat frame, wherein the plurality of flat layers (e.g., layers 40-50) is stacked upon one another, and wherein the plurality of stacked layers (e.g., layers 40-50) varies in sequentially increasing density from an occupant support surface (e.g., layer 50) to a base layer (e.g., 40), which may provide a transition in density and firmness from comfort support at an occupant contact surface at the comfort layer to structural support at the base layer, which may include a high-density material such as an elastomer, ethylene propylene diene monomer rubber, a thermoplastic polyurethane, and/or an expanded polyvinylchloride. The base layer may provide a substrate or shell for the intermediate layers, and the comfort layer.

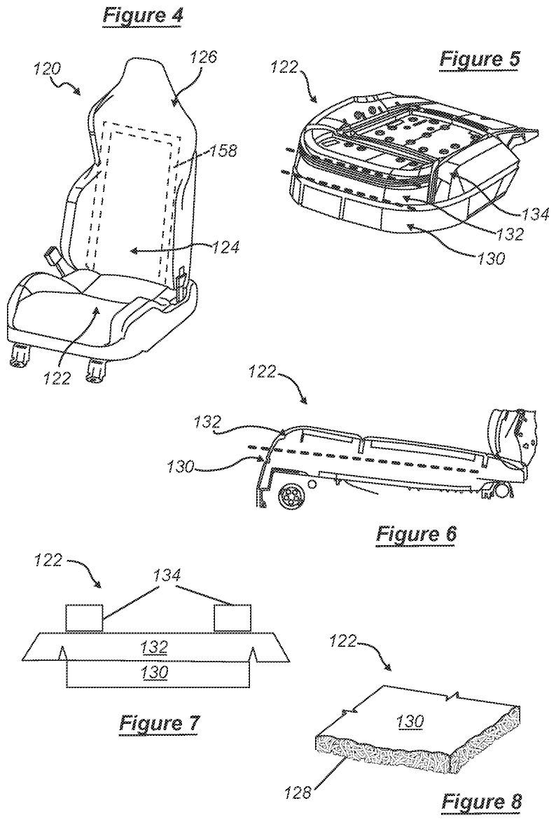

FIG. 4 illustrates a seat assembly 120 as a vehicle seat assembly 120 according some embodiments. Although the vehicle seat assembly 120 is illustrated and described, any seat assembly 120 may be employed. The seat assembly 120 may be utilized in a land vehicle, aircraft, watercraft, or the like. The seat assembly 120 may also be utilized as an office chair, comfort chair, or the like.

The depicted seat assembly 120 includes a seat bottom cushion 122 to support a pelvis and thighs of a seated occupant. The seat assembly 120 also includes a seat back cushion 124 to support a back and shoulders of the seated occupant. A trim cover 126 is provided over the seat cushions 122, 124 to conceal the cushions 122, 124 and provide a uniform and smooth contact surface for the occupant.

FIGS. 5-7 illustrate the seat bottom cushion 122 illustrated disassembled from the seat assembly 120. The seat bottom cushion 122 has an overall unitary seat cushion 122 design. Such designs are conventional as seat cushion designs are typically designed with the end product in mind. Subsequent changes are then incorporated to support the associated manufacturing processes.

Referring now to FIG. 8, a portion of the seat cushion 122 is partially illustrated disassembled from the seat assembly 120. The seat cushion 122 is formed from a plurality of strands 128 or three-dimensional filament loops of an extruded, expanded thermoplastic resin or polymer. The seat cushion 122 is also formed with a base layer 130 bonded to, and/or formed unitarily with, the plurality of strands 128. The extruded mesh cushion 122 is readily fabricated with a rectangular cross-section or to a consistent thickness.

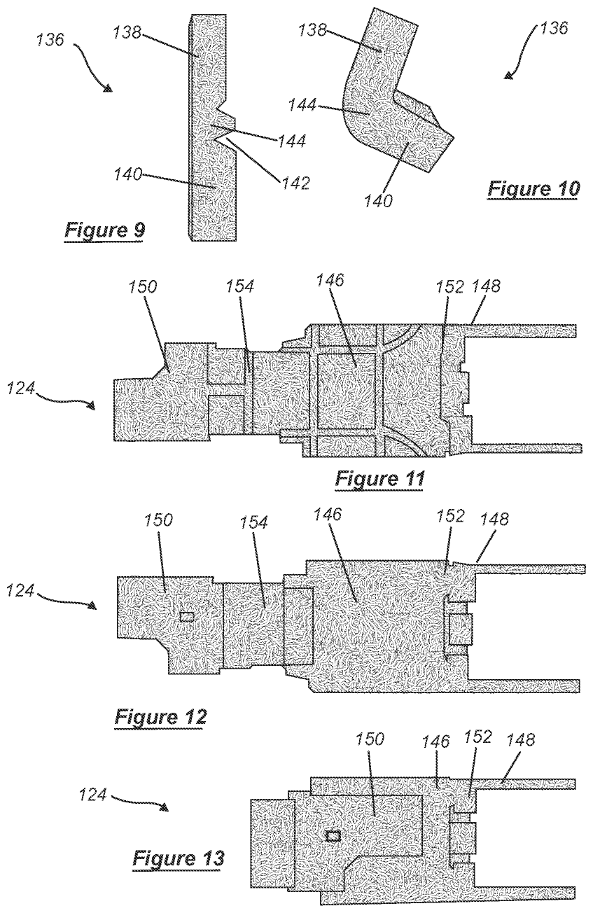

Referring again to FIGS. 5-7, the seat cushion 122 is redesigned into three layers, sections, or cushion segments 130, 132, 134. The cushions segments 130, 132, 134 are collectively stacked upon each other to collectively provide the seat cushion 122. The segments 130, 132, 134 are each designed to a have a common maximum thickness so that the segments 130, 132, 134 can be formed integrally as one sheet of extruded mesh 128, and subsequently stacked. Additionally, the segments 130, 132, 134 may be pivotally interconnected to stack upon each other. With reference to FIG. 7, the outside parallelograms of the central segment 132 are designed to pivot upward and mate with lateral outboard surfaces of the upper segment 134.

FIG. 9 illustrates a side view of a portion of a cushion 136 according to an embodiment. The cushion 136 includes a pair of cushion segments 138, 140 formed integrally as a unitary mesh 128 of extruded thermoplastic resin. A pair of recesses 142 are formed into a surface of the form to define a hinge 144 pivotally connecting the cushion segments 138, 140. As illustrated in FIG. 10, the cushion segments 138, 140 can be pivoted about the hinge 144. Any quantity of recesses 142, and any pivotal range may be employed to pivot and/or stack the cushion segments 138.

FIG. 11 illustrates the seat back cushion 124 illustrated partially disassembled. The seat back cushion 124 is formed from a unitary sheet of extruded thermoplastic mesh 128 with a uniform thickness. The seat back cushion 124 is illustrated after a secondary forming operation, such as cutting to incorporate various cushion details. The cutting operation is performed by automation, such as waterjet cutting, laser cutting, die-cutting, or the like. The seat back cushion 124 includes three cushion segments 146, 148, 150.

The central segment 146 is a forward-facing segment of the seat back cushion 124. The upper segment 148 is a rearward-facing segment and is pivotally connected to the central segment 146 along a hinge 152. The lower segment 150 is also a rearward-facing segment and is pivotally connected to the central segment 146 along a hinge 154 that is spaced apart from the upper hinge 152.

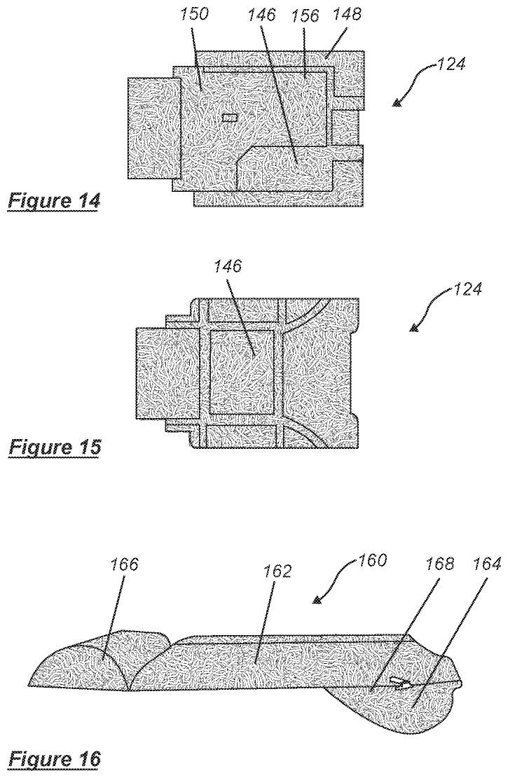

FIG. 12 illustrates a rear side of the cushion 124 in the expanded orientation. The exposed surface on the rear side is generally flat to facilitate mating surfaces of the segments 146, 148, 150. As illustrated from FIG. 12 to FIG. 13, the lower segment 150 is pivoted about the hinge 154 and stacked flat upon the rear surface of the central segment 146. From FIG. 13 to FIG. 14, the upper segment 148 is pivoted about the hinge 152 and stacked flat upon the rear surface of the central segment 146.

The segments 146, 148, 150 may then be secured together by heat staking, welding, adhesive, a fastener, a hook and loop fastener, a retainer, or the like. FIG. 14 illustrates the rear surface of the assembled seat back cushion 124. Collectively, the segments form a trench 156 for attachment to a seat back frame 158 (FIG. 4). FIG. 15 illustrates the front surface of the assembled seat back cushion 124.

The firmness and/or compliance of each seat cushion 122, 124 is designed by a quantity, material, material density, strand thickness, or the like of the segments. By providing each segment with a common maximum thickness, a common retainer, such as a trim member may be attached to any of the segments. The seat cushions 122, 124 may attach directly to the seat frame, or may attach to a foam support layer, a polyurethane carrier, or any other seat support member.

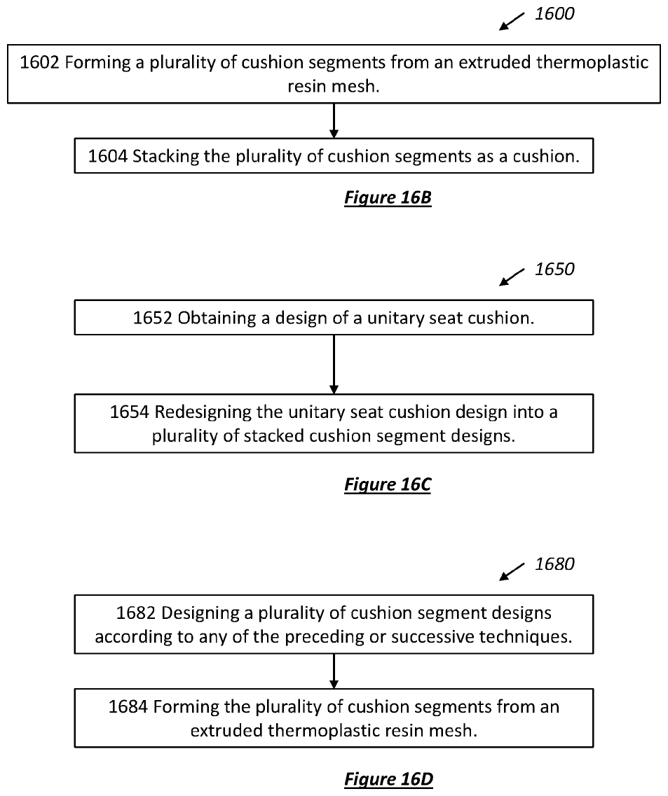

FIG. 16 illustrates a cushion 160 according to another embodiment. Similar to the prior embodiments, the cushion 160 includes a plurality of integrally formed and pivotally interconnected segments 162, 164, 166. A fastener 168 is provided along a seam between two of the segments 162, 164. The fastener 168 may be a heat stake, a weld, an adhesive, a hook and loop fastener, a retainer, or the like.

A seat support (e.g., 122, 124, and/or 136) is described, which may be a seat bottom cushion, a seat back cushion, a head restraint, a headrest, a bolster, a region, and/or a portion. The seat support (e.g., 122, 124, and/or 136) comprises a plurality of layers (e.g., 130, 132, 134, 138, and/or 140), segments, sections, a base, and/or a bolster, of an extruded thermoplastic resin mesh, which may be an extruded thermoplastic resin mesh, strands, three-dimensional filament loops of an extruded, expanded thermoplastic resin or polymer, plurality of fused connections in which two loops are attached to each other, independently include from 60 to 95 volume percent air, density from about 0.01 to 0.200 g/cm³, to mount to a seat frame, which may be a stamped steel alloy, a fiber reinforced polymer, or any suitable structural material, wire suspension mats, a substrate, and/or a panel, and to support an occupant upon the seat frame. The plurality of layers (e.g., 130, 132, 134, 138, and/or 140) is stacked upon each other, and may be attached with a retention clip having an end embedded in the foam and a retention clip end attached to the plastic mesh base, hook and loop connector strips, hook layers, loop layers, adhesives, hog rings, single- or double-sided retention clips, bonded, welded, sewn, fastened, adhered, heat staked, and/or retained.

In some embodiments, at least one of the plurality of stacked layers (e.g., 130, 132, 134, 138, and/or 140) has a generally uniform thickness, which may have rectangular cross-section, a consistent thickness, and/or a parallelogram shape.

In some embodiments, each of the plurality of stacked layers (e.g., 130, 132, 134, 138, and/or 140) has a generally uniform thickness.

In some embodiments, the seat support (e.g., 122, 124, and/or 136) further comprises at least two stacked layers (e.g., 130, 132, 134, 138, and/or 140).

In some embodiments, each of the plurality of stacked layers (e.g., 162, 164, and/or 166) are pivotally connected to each other.

In some embodiments, at least one recess is formed into one of the plurality of stacked layers (e.g., 162, 164, 166) to provide the pivotal connection.

In some embodiments, each of the plurality of stacked layers (e.g., 162, 164, 166) are formed integrally or unitary.

A seat assembly (e.g., 120) is described, which may be a vehicle seat, office chair, individual chair, and/or the like. The seat assembly (e.g., 120) comprises a seat frame and a seat support (e.g., 122, 124, and/or 136) attached to the seat frame.

A seat support (e.g., 122, 124, and/or 136) is described, which may be a seat bottom cushion, a seat back cushion, a head restraint, a headrest, a bolster, a region, and/or a portion. The seat support (e.g., 122, 124, and/or 136) comprises a plurality of layers (e.g., 130, 132, 134, 138, and/or 140), segments, sections, a base, and/or a bolster, to mount to a seat frame, which may be a stamped steel alloy, a fiber reinforced polymer, or any suitable structural material, wire suspension mats, a substrate, and/or a panel, and to support an occupant upon the seat frame. The plurality of layers (e.g., 130, 132, 134, 138, and/or 140) is stacked upon each other, and may be attached with a retention clip having an end embedded in the foam and a retention clip end attached to the plastic mesh base, hook and loop connector strips, hook layers, loop layers, adhesives, hog rings, single- or double-sided retention clips, bonded, welded, sewn, fastened, adhered, heat staked, and/or retained. At least one of the plurality of stacked layers (e.g., 162, 164, and/or 166) has a generally uniform thickness, which may have rectangular cross-section, a consistent thickness, and/or a parallelogram shape. Each of the plurality of stacked layers are formed integrally and/or unitarily. Each of the plurality of stacked layers (e.g., 162, 164, and/or 166) are pivotally connected to each other.

FIG. 16B illustrates a method 1600 in accordance with some embodiments. Method 1600 is for manufacturing a cushion (e.g., cushion 122, 124, 130, 132, 134, 138, and/or 140), which may be a seat bottom cushion, a seat back cushion, a head restraint, a headrest, a bolster, a region, and/or a portion. In various examples, method 1600 may have greater or fewer steps than described below, and various steps may be performed in another order, sequentially, or simultaneously.

Method 1600 of manufacturing a product is described, which may be a seat bottom cushion, a seat back cushion, a head restraint, a headrest, a bolster, a region, and/or a portion. Method 1600 comprises forming (1602) a plurality of cushion segments (e.g., 130, 132, 134, 138, and/or 140) from an extruded thermoplastic resin mesh, which may be an extruded thermoplastic resin mesh, strands, three-dimensional filament loops of an extruded, expanded thermoplastic resin or polymer, and/or a plurality of fused connections in which two loops are attached to each other, independently include from 60 to 95 volume percent air, density from about 0.01 to 0.200 g/cm³, and stacking (1604) the plurality of cushion segments (e.g., 130, 132, 134, 138, and/or 140) as a cushion (e.g., cushion 122, 124, and/or 160).

In some embodiments, method 1600 comprises shaping the plurality of cushion segments (e.g., 130, 132, 134, 138, and/or 140), which may be cutting, die cut, robotic laser cutting, waterjet cutting, laser cutting, and/or other flexible automation.

In some embodiments, method 1600 comprises forming the plurality of cushion segments (e.g., 162, 164, 166) as an integral sheet.

In some embodiments, method 1600 comprises folding the cushion segments (e.g., 162, 164, 166) to stack the cushion segments upon one another.

In some embodiments, method 1600 comprises forming at least one recess in at least one of the plurality of cushion segments (e.g., 162, 164, 166) to fold the cushion segments.

In some embodiments, method 1600 comprises cutting the plurality of cushion segments (e.g., 146, 148, 150) to shape the plurality of cushion segments, which may include die cutting, robotic laser cutting, waterjet cutting, laser cutting, and/or other flexible automation.

A seat support is described, which may be a seat bottom cushion, a seat back cushion, a head restraint, a headrest, a bolster, a region, and/or a portion. The seat support is manufactured from any of the preceding or successive techniques.

In some embodiments, method 1600 comprises installing the product to a seat frame, which may be a stamped steel alloy, a fiber reinforced polymer, or any suitable structural material, wire suspension mats, a substrate, and/or a panel.

A seat assembly is described, which may be a vehicle seat, office chair, individual chair, and/or the like. The seat assembly is manufactured by the method of any of the preceding or successive techniques.

The technique described above with respect to method 1600 is optionally combined with one or more elements of the methods described above and/or below. For example, this method can be used in conjunction with one or more methods 400, 1650, 1680, 2700, 3800.

FIG. 16C illustrates a method 1650 in accordance with some embodiments. Method 1650 is for manufacturing a cushion (e.g., cushion 122, 124, 130, 132, 134, 138, and/or 140), which may be a seat bottom cushion, a seat back cushion, a head restraint, a headrest, a bolster, a region, and/or a portion. In various examples, method 1650 may have greater or fewer steps than described below, and various steps may be performed in another order, sequentially, or simultaneously.

Method 1650 is for designing a seat cushion, which may be a seat bottom cushion, a seat back cushion, a head restraint, a headrest, a bolster, a region, and/or a portion. Method 1650 comprises obtaining (1652) a design of a unitary seat cushion (e.g., unitary seat cushion 122) and redesigning (1654) the unitary seat cushion design into a plurality of stacked cushion segment designs (e.g., 130, 132, and/or 134), layers, sections, a base, and/or a bolster.

In some embodiments, method 1650 comprises redesigning the unitary seat cushion design into the plurality of stacked cushion segment designs each with a common maximum thickness.

The technique described above with respect to method 1650 is optionally combined with one or more elements of the methods described above and/or below. For example, this method can be used in conjunction with methods 400, 1600, 1680, 2700, 3800.

FIG. 16D illustrates a method 1680 in accordance with some embodiments. Method 1680 is for manufacturing a seat cushion (e.g., cushion 122, 124, 130, 132, 134, 138, and/or 140), which may be a seat bottom cushion, a seat back cushion, a head restraint, a headrest, a bolster, a region, and/or a portion. In various examples, method 1680 may have greater or fewer steps than described below, and various steps may be performed in another order, sequentially, or simultaneously.

Method 1680 comprises designing (1682) a plurality of cushion segment designs according to any of the preceding or successive techniques and forming (1684) the plurality of cushion segments from an extruded thermoplastic resin mesh, which may be an extruded thermoplastic resin mesh, strands, three-dimensional filament loops of an extruded, expanded thermoplastic resin or polymer, and/or a plurality of fused connections in which two loops are attached to each other, independently include from 60 to 95 volume percent air, density from about 0.01 to 0.200 g/cm³.

In some embodiments, method 1680 comprises stacking the plurality of cushion segments as a cushion, which may be a seat bottom cushion, a seat back cushion, a head restraint, a headrest, a bolster, a region, and/or a portion.

The technique described above with respect to method 1680 is optionally combined with one or more elements of the methods described above and/or below. For example, this method can be used in conjunction with one or more methods 400, 1600, 1650, 2700, 3800.

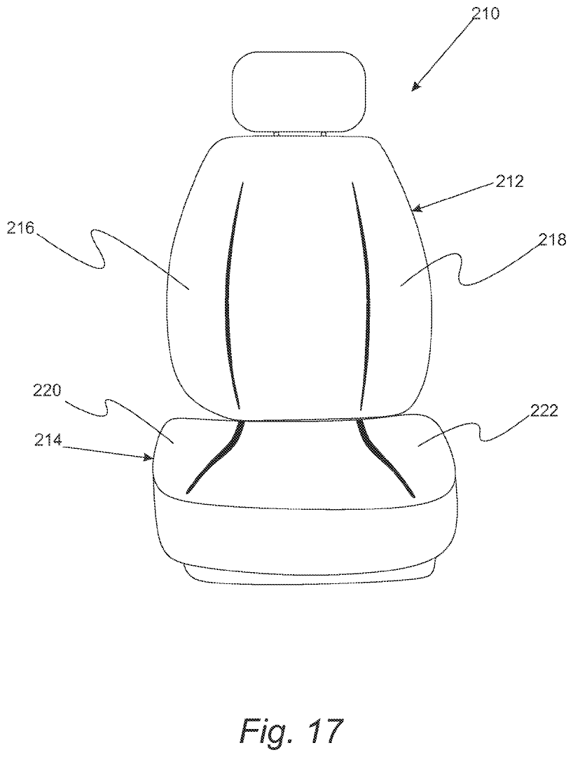

With reference to FIG. 17, a perspective view of a vehicle seat 210 having an extruded plastic mesh base plastic with mesh bolsters is provided. Vehicle seat 210 includes seat back 212 and seat bottom 214. Seat back 212 includes right seat back bolster 216 and left seat back bolster 218. Seat bottom 214 includes right seat bottom bolster 220 and left seat bottom bolster 222.

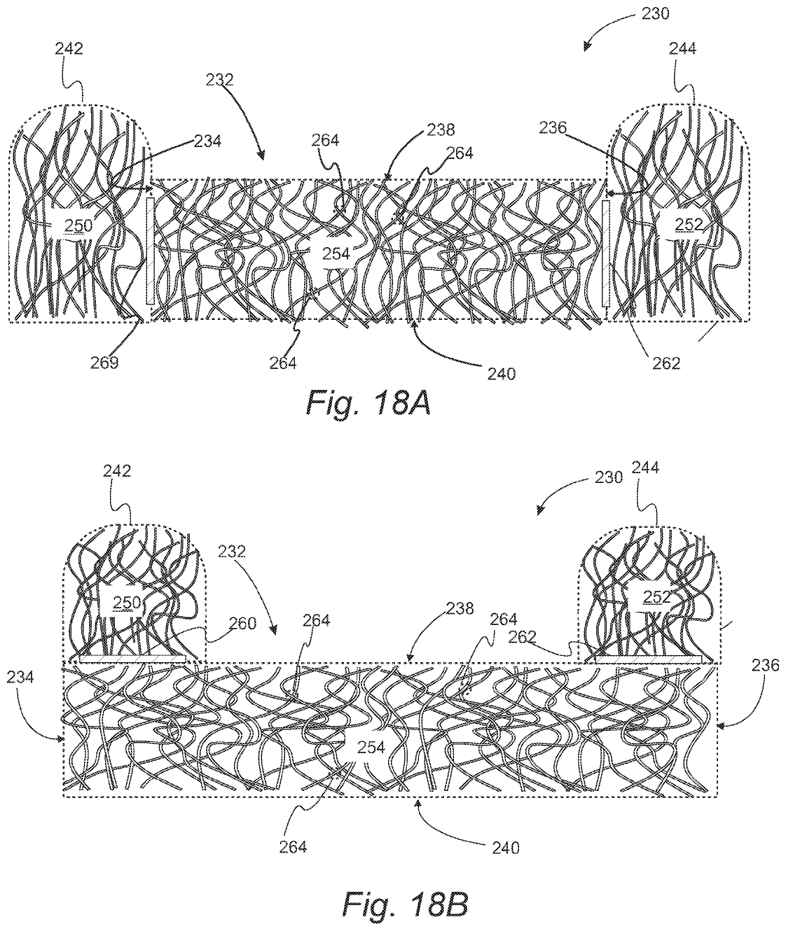

FIGS. 18A and 18B depict a cross-section of a seat support as a vehicle seat cushion component 230. Advantageously, the vehicle seat cushion component 230 can be part of vehicle seat back 212 or a vehicle seat bottom 214. Vehicle seat component 230 includes a layer as a plastic mesh base 232. Plastic mesh base 232 has a first edge 234, a second edge 236, a first face 238, and a second face 240. A first plastic mesh bolster 242 is another layer attached to the plastic mesh base 232 at the first edge 234. A second plastic mesh bolster 244 is another layer attached to the plastic mesh base 232 at the second edge 236. First plastic mesh bolster 242 includes a first plurality of three-dimensional filament loops 250 or filaments composed of a first thermoplastic resin or polymer. Second plastic mesh bolster 244 includes a second plurality of three-dimensional filament loops 252 or filaments composed of a second thermoplastic polymer. The first plurality of three-dimensional filament loops 250 and the second plurality of three-dimensional filament loops 252 are each independently shaped into a form suitable for a vehicle seat bolster 242, 244. The dotted lines about these components highlight the shape of these bolster components. Similarly, plastic mesh base 232 includes a third plurality of three-dimensional filament loops 254 composed of a third thermoplastic polymer. The third plurality of three-dimensional filament loops 254 is shaped into a general block shape or any shape suitable to function as a cushion. FIG. 18A depicts a refinement in which the first plastic mesh bolster 242 is attached to the first edge 234 and the second plastic mesh bolster 244 is attached to the second edge 236 while FIG. 18B depicts a refinement in which the first plastic mesh bolster 242 and the second plastic mesh bolster 244 are each disposed over the first face 238.

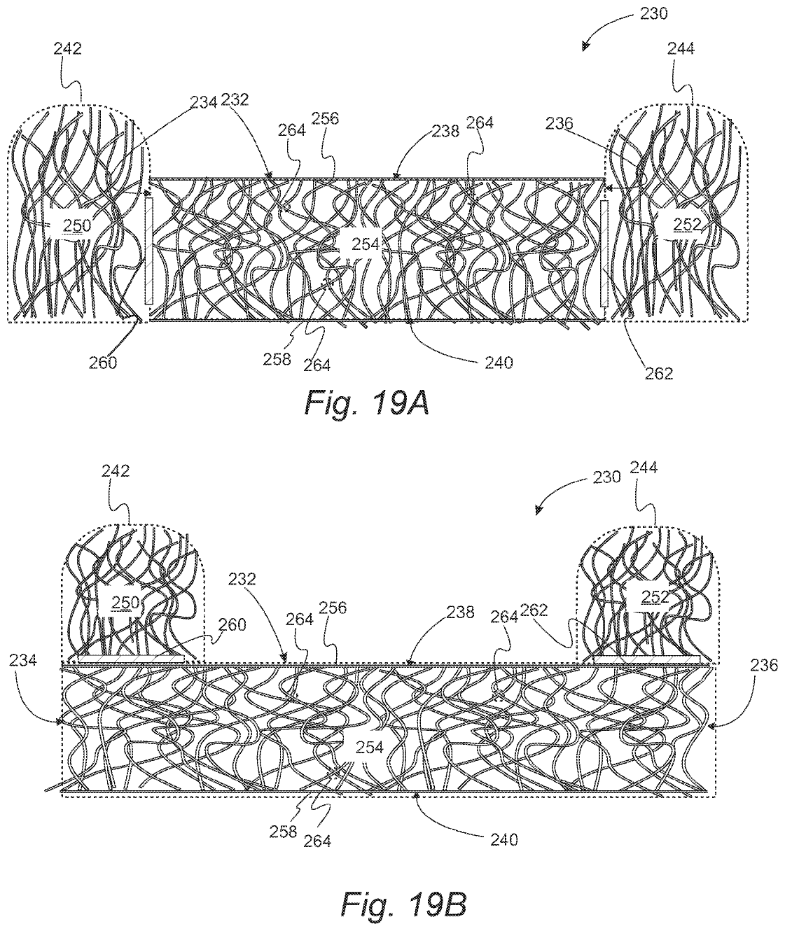

FIGS. 19A and 19B depict a cross-section of another variation of vehicle seat cushion component 230. As set forth above, the vehicle seat cushion component 230 can be part of a vehicle seat back 212 or a vehicle seat bottom 214. Vehicle seat component 230 includes plastic mesh base 232. Plastic mesh base 232 has a first edge 234, a second edge 236, a first face 238, and a second face 240. A first plastic mesh bolster 242 is attached to the plastic mesh base 232 at the first edge 234. A second plastic mesh bolster 244 is attached to the plastic mesh base 232 at the second edge 236. First plastic mesh bolster 242 includes a first plurality of three-dimensional filament loops 250 composed of a first thermoplastic polymer. Second plastic mesh bolster 244 includes a second plurality of three-dimensional filament loops 252 composed of a second thermoplastic polymer. The first plurality of three-dimensional filament loops 250 and the second plurality of three-dimensional filament loops 252 are each independently shaped into a form suitable for a vehicle seat bolster 242, 244. The dotted lines about these components highlight the shape of these bolster components. Similarly, plastic mesh base 232 includes a third plurality of three-dimensional filament loops 254 composed of a third thermoplastic polymer. The third plurality of three-dimensional filament loops 254 is shaped into a general block shape or any shape suitable to function as a cushion. Optional skin layer 256 is disposed over and contacts the first face 238 of the shaped plurality of three-dimensional filament loops 254. Vehicle seat component 230 can include one or both of skin layers 256 and 258.

Referring to FIGS. 18A, 18B, 19A, and 19B, the first plastic mesh bolster 242 is attached to the plastic mesh base 232 and the second plastic mesh bolster 244 is attached to the plastic mesh base 232. These attachments 260 and 262 can be any attachment mechanism known to those skilled in the art such as Velcro connector strips (hook layers and loop layers), adhesives, hog rings, single or double-sided retention clips, and the like.

Examples of methods for forming and properties of the first, second, and third pluralities of three-dimensional filament loops are disclosed in U.S. Pat. Nos. 10,233,073 and 9,918,559; the entire disclosures of which are hereby incorporated by reference in their entirety.

Referring to FIGS. 18A, 18B, 19A, and 19B, independently at least a subset of loops in the first plurality of three-dimensional filament loops 250, at least a subset of loops in the second plurality of three-dimensional filament loops 252, and at least a subset of loops in the third plurality of three-dimensional filament loops 254 are not parallel or aligned with each other. In a refinement, independently at least a subset of loops in the first plurality of three-dimensional filament loops 250, at least a subset of loops in the second plurality of three-dimensional filament loops 252, and at least a subset of loops in the third plurality of three-dimensional filament loops 254 are randomly oriented.

In a variation, first plastic mesh bolster 242, second plastic mesh bolster 244, and plastic mesh base 232 independently include from 60 to 95 volume percent air. In some refinements, first plastic mesh bolster 242, second plastic mesh bolster 244, and plastic mesh base 232 independently include at least in increasing order of preference 60, 65, 70, 75, or 80 volume percent air and at most in increasing order of preference 95, 93, 90, 85, or 80 volume percent air. In a refinement, first plastic mesh bolster 242, second plastic mesh bolster 244, and plastic mesh base 232 independently has a density from about 0.01 to 0.200 g/cm³. In some refinement, the plurality of three-dimensional filament loops includes a plurality of fused connections 264 in which two loops are attached to each other.

In a variation, three-dimensional filament loops 250, three-dimensional filament loops 252, and three-dimensional filament loops 254, and any optional skin layers if present are independently composed of a thermoplastic polymer. In a refinement, the three-dimensional filament loops are extruded thermoplastic polymers. Examples of the thermoplastic polymer include, but are not limited to polyolefin, polystyrene-based thermoplastic elastomer, polyester-based thermoplastic elastomer, polyurethane-based thermoplastic elastomer, and polyamide-based thermoplastic elastomer. In a refinement, the thermoplastic polymer includes linear low-density polyethylene. In some refinement, the three-dimensional filament loops have a fineness from 200 to 10000 decitex. In a refinement, the three-dimensional filament loops have a fineness from 200 to 5000 decitex. In a further refinement, the three-dimensional filament loops have a fineness from 200 to 3000 decitex.

A vehicle seat cushion (e.g., vehicle seat cushion component 230) is described, which may be a seat bottom cushion, a seat back cushion, a head restraint, a headrest, a bolster, a region, and/or a portion. The vehicle seat cushion (e.g., vehicle seat cushion component 230) comprises a first plastic mesh bolster (e.g., first plastic mesh bolster 242), which may be formed by compression molding, including a first plurality of three-dimensional filament loops (e.g., loops 250), which at least a subset of loops in the first plurality of three-dimensional filament loops may or may not be parallel or aligned with each other, may be randomly oriented, and may have a fineness from 200 to 10000 decitex. The first plurality of three-dimensional filament loops is composed of a first thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene. The vehicle seat cushion (e.g., vehicle seat cushion component 230) comprises a second plastic mesh bolster (e.g., second plastic mesh bolster 244), which may be formed by compression molding, including a second plurality of three-dimensional filament loops (e.g., loops 252), which at least a subset of loops in the second plurality of three-dimensional filament loops may or may not be parallel or aligned with each other, may be randomly oriented, and may have a fineness from 200 to 10000 decitex. The second plurality of three-dimensional filament loops is composed of a second thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene. The vehicle seat cushion (e.g., vehicle seat cushion component 230) comprises a plastic mesh base (e.g., plastic mesh base 232), which may be an extruded thermoplastic resin mesh, strands, three-dimensional filament loops of an extruded, expanded thermoplastic resin or polymer, plurality of fused connections in which two loops are attached to each other, independently include from 60 to 95 volume percent air, density from about 0.01 to 0.200 g/cm³, including a third plurality of three-dimensional filament loops (e.g., loops 254), which at least a subset of loops in the third plurality of three-dimensional filament loops may or may not be parallel or aligned with each other, may be randomly oriented, and may have a fineness from 200 to 10000 decitex. The third plurality of three-dimensional filament loops is composed of a third thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene. The plastic mesh base may have a block shape, and the plastic mesh base has a first edge (e.g., first edge 234), a second edge (e.g., second edge 236), a first face (e.g., first face 238), and a second face (e.g., second face 240). The first plastic mesh bolster (e.g., first plastic mesh bolster 242) is attached to the plastic mesh base (e.g., plastic mesh base 232) at the first edge (e.g., first edge 234) and the second plastic mesh bolster (e.g., second plastic mesh bolster 244) is attached to the plastic mesh base (e.g., plastic mesh base 232) at the first edge (e.g., first edge 234). The attachments may be with a retention clip having an end embedded in the foam and a retention clip end attached to the plastic mesh base, hook and loop connector strips, hook layers, loop layers, adhesives, hog rings, single- or double-sided retention clips, bonded, welded, sewn, fastened, adhered, heat staked, and/or otherwise retained.

In some embodiments, the vehicle seat cushion component (e.g., vehicle seat cushion component 230) is included in a vehicle seat back (e.g., vehicle seat back 212) or a vehicle seat bottom (e.g., vehicle seat bottom 214).

In some embodiments, the first plurality of three-dimensional filament loops (e.g., loops 250), the second plurality of three-dimensional filament loops (e.g., loops 252), and the third plurality of three-dimensional filament loops each independently include a plurality of fused connection in which two loops are attached to each other.

In some embodiments, the first plurality of three-dimensional filament loops (e.g., loops 250) and the second plurality of three-dimensional filament loops (e.g., loops 252) are each independently shaped into a form for a vehicle seat bolster.

In some embodiments, the first plastic mesh bolster (e.g., first plastic mesh bolster 242) and the second plastic mesh bolster are each disposed over the first face.

In some embodiments, the first plastic mesh bolster (e.g., first plastic mesh bolster 242) is attached to the first edge and the second plastic mesh bolster is attached to the second edge.

In some embodiments, the first plastic mesh bolster (e.g., first plastic mesh bolster 242) and the second plastic mesh bolster are attached to the plastic mesh base (e.g., plastic mesh base 232) by hook and loop strips, an adhesive, a retention clip, and/or a hog ring.

In some embodiments, at least a subset of loops in the first plurality of three-dimensional filament loops (e.g., loops 250), at least a subset of loops in the second plurality of three-dimensional filament loops (e.g., loops 252), and at least a subset of loops in the third plurality of three-dimensional filament loops are not parallel or aligned with each other.

In some embodiments, at least a subset of loops in the first plurality of three-dimensional filament loops (e.g., loops 250), at least a subset of loops in the second plurality of three-dimensional filament loops (e.g., loops 252), and at least a subset of loops in the third plurality of three-dimensional filament loops are randomly oriented.

In some embodiments, a first skin layer is disposed over the first face of the plastic mesh base (e.g., plastic mesh base 232).

In some embodiments, a first skin layer is disposed over the second face of the plastic mesh base (e.g., plastic mesh base 232).

In some embodiments, the first plastic mesh bolster (e.g., first plastic mesh bolster 242), the first plastic mesh bolster, and the plastic mesh base (e.g., plastic mesh base 232) independently include from 60 to 95 volume percent air.

In some embodiments, the first plastic mesh bolster (e.g., first plastic mesh bolster 242), the first plastic mesh bolster, and the plastic mesh base independently have a density from about 0.01 to 0.200 g/cm³.

In some embodiments, the first thermoplastic polymer, the second thermoplastic polymer, and the third thermoplastic polymer are each independently an extruded thermoplastic polymer.

In some embodiments, the first thermoplastic polymer, the second thermoplastic polymer, and the third thermoplastic polymer are each independently composed of a component selected from the group consisting of polyolefin, polystyrene-based thermoplastic elastomer, polyester-based thermoplastic elastomer, polyurethane-based thermoplastic elastomer, and polyamide-based thermoplastic elastomer.

In some embodiments, the first thermoplastic polymer, the second thermoplastic polymer, and the third thermoplastic polymer are each independently a linear low-density polyethylene.

In some embodiments, the first plurality of three-dimensional filament loops (e.g., loops 250), the second plurality of three-dimensional filament loops (e.g., loops 252), and the third plurality of three-dimensional filament loops have a fineness from 200 to 10000 decitex.

A vehicle seat cushion component (e.g., 230) is described, which may be a seat bottom cushion, a seat back cushion, a head restraint, a headrest, a bolster, a region, and/or a portion. The vehicle seat cushion component (e.g., 230) comprises: a first plastic mesh bolster (e.g., 242), which may be formed by compression molding, including a first plurality of three-dimensional filament loops (e.g., 250), which at least a subset of loops in the first plurality of three-dimensional filament loops may or may not be parallel or aligned with each other, may be randomly oriented, and may have a fineness from 200 to 10000 decitex. The first plurality of three-dimensional filament loops is composed of a first thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene. The vehicle seat cushion component (e.g., 230) comprises: a second plastic mesh bolster (e.g., 244), which may be formed by compression molding, including a second plurality of three-dimensional filament loops (e.g., 252), which at least a subset of loops in the second plurality of three-dimensional filament loops may or may not be parallel or aligned with each other, may be randomly oriented, and may have a fineness from 200 to 10000 decitex. The second plurality of three-dimensional filament loops is composed of a second thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene. The vehicle seat cushion component (e.g., 230) comprises: a plastic mesh base (e.g., 232), which may be an extruded thermoplastic resin mesh, strands, three-dimensional filament loops of an extruded, expanded thermoplastic resin or polymer, plurality of fused connections in which two loops are attached to each other, independently include from 60 to 95 volume percent air, density from about 0.01 to 0.200 g/cm³, including a third plurality of three-dimensional filament loops (e.g., 254), which at least a subset of loops in the third plurality of three-dimensional filament loops may or may not be parallel or aligned with each other, may be randomly oriented, and may have a fineness from 200 to 10000 decitex. The third plurality of three-dimensional filament loops is composed of a third thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene. The plastic mesh base (e.g., 232) has a first edge, a second edge, a first face, and a second face. The first plastic mesh bolster (e.g., 242) is attached to the plastic mesh base (e.g., 232) at the first edge and the second plastic mesh bolster is attached to the plastic mesh base at the first edge. The attachments may be with a retention clip having an end embedded in the foam and a retention clip end attached to the plastic mesh base, hook and loop connector strips, hook layers, loop layers, adhesives, hog rings, single- or double-sided retention clips, bonded, welded, sewn, fastened, adhered, heat staked, and/or otherwise retained. The first plurality of three-dimensional filament loops (e.g., 250), the second plurality of three-dimensional filament loops (e.g., 252), and the third plurality of three-dimensional filament loops (e.g., 254) each independently include a plurality of fused connections in which two loops are attached to each other.

In some embodiments, the vehicle seat cushion component (e.g., 230) is included in a vehicle seat back or a vehicle seat bottom.

In some embodiments, the plastic mesh base (e.g., 232) is from 60 to 95 volume percent air.

In some embodiments, the first thermoplastic polymer, the second thermoplastic polymer, and the third thermoplastic polymer are each independently composed of a component selected from the group consisting of polyolefin, polystyrene-based thermoplastic elastomer, polyester-based thermoplastic elastomer, polyurethane-based thermoplastic elastomer, and polyamide-based thermoplastic elastomer.

The technique described above is optionally combined with one or more elements of the methods described above/below. For example, these parts can be used in conjunction with one or more methods 400, 1600, 1650, 1680, 2700, 3800.

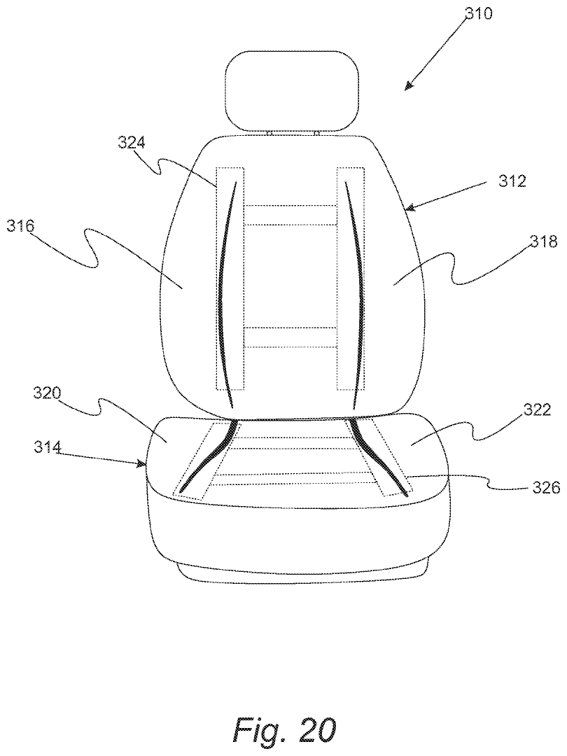

With reference to FIG. 20, a perspective view of a vehicle seat 310 having an extruded plastic mesh base is provided. Vehicle seat 310 includes seat back 312 and seat bottom 314. Seat back 312 includes right seat back bolster 316 and left seat back bolster 318. Seat bottom 314 includes right seat bottom bolster 320 and left seat bottom bolster 322. Seat back 312 also includes a seat back frame 324 for mounting a seat back cushion component thereon. Similarly, seat bottom 314 includes a seat bottom frame 326 for mounting a seat bottom cushion component thereon.

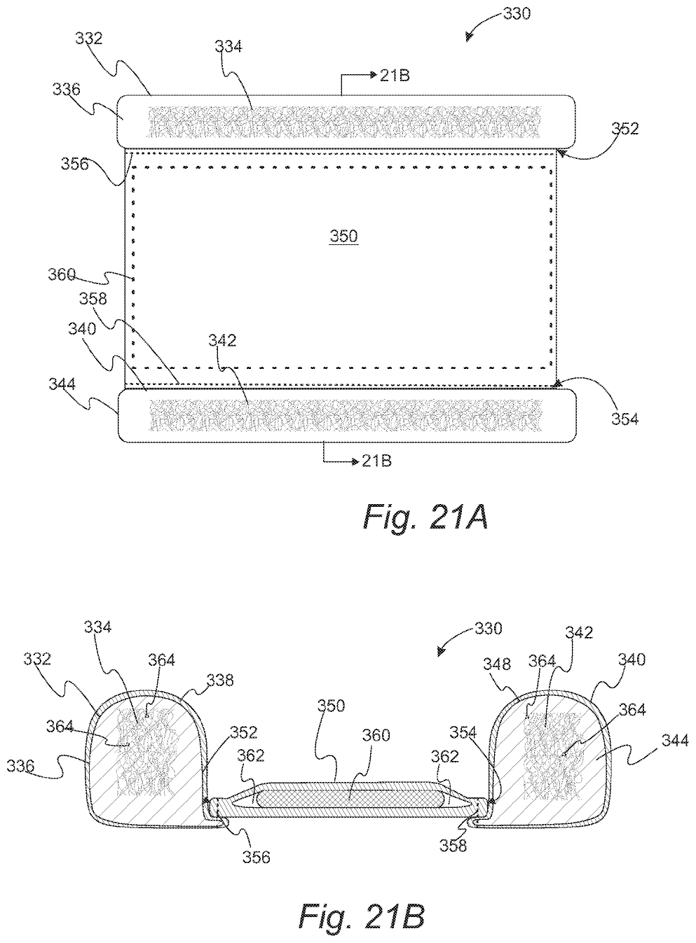

With reference to FIGS. 21A and 21B, schematic illustrations of a vehicle seat component 330 are provided. Vehicle seat component 330 includes a first bolster assembly 332. First bolster assembly 332 includes a first core cushion section 334, layer, or segment, surrounded by a first outer bolster covering 336 of a first non-woven material. First bolster trim covering 338 surrounds first outer bolster covering 336. A second bolster assembly 340 includes a second core cushion section 342, layer, or segment, surrounded by a second outer bolster covering 344 of a second non-woven material. Second bolster trim covering 348 surrounds second outer bolster covering 344. A trim covering section 350 includes a first edge 352 and a second edge 354. Characteristically, the first bolster assembly 332 is sewn to the trim covering section at the first edge at sew line 356. Similarly, the second bolster assembly 340 is sewn to the trim covering section at the second edge at sew line 358. In a variation, vehicle seat component 330 further includes a central cushion component 360 positioned in an opening 362 defined by the trim covering section.

In a refinement, the first outer bolster covering 336 and the second outer bolster covering 344 each independently include a non-woven fabric or a woven fabric. For example, the first outer bolster covering 336 and the second outer bolster covering 344 each independently include natural fibers (e.g., jute fibers).

In a variation, the first bolster assembly 332 and the second bolster assembly 340 are each independently fabricated by compression molding. For example, a layered/sandwiched assembly of Jute or nonwoven material and core cushion section can be formed by compression molding. In a refinement, each bolster assembly includes a top layer Jute/nonwoven fabric, a middle cushion section, and a bottom layer of Jute/nonwoven fabric.

In a variation, the trim covering section defines an opening 362 for receiving a central cushion component 360.

In a variation, the first core cushion section 334, the second core cushion section 342, and the central cushion component 360 are each independently composed of foamed polymer. In a refinement, the first core cushion section 334 and the second core cushion section 342 are each independently composed of a foamed polyurethane. As is known in the art, foamed polyurethanes are formed from the reaction of isocyanates, polyols, and a suitable blowing agent.

In another variation as depicted in FIGS. 21A and 21B, the first core cushion section 334, the second core cushion section 342, and the central cushion component 360 are each independently composed of a plurality of three-dimensional filament loops or strands composed of a thermoplastic polymer or resin. In a refinement, at least a subset of loops in the plurality of three-dimensional filament loops are not parallel or aligned with each other. In a refinement, loops in the plurality of three-dimensional filament loops are randomly oriented.

Still referring to FIGS. 21A and 21B, in another variation, the first core cushion section 334, the second core cushion section 342, and the central cushion component 360 each independently include a plurality of three-dimensional filament loops having from 60 to 95 volume percent air. In some refinements, the first core cushion section 334, the second core cushion section 342, and the central cushion component 360 each independently include a plurality of three-dimensional filament loops having at least in increasing order of preference 60, 65, 70, 75, or 80 volume percent air and at most in increasing order of preference 95, 93, 90, 85, or 80 volume percent air. In a refinement, the first core cushion section 334, the second core cushion section 342, and the central cushion component 360 independently include a plurality of three-dimensional filament loops has a density from about 0.01 to 0.200 g/cm³. In some refinements, the plurality of three-dimensional filament loops includes a plurality of fused connections 364 in which two loops are attached to each other.

In a refinement, the three-dimensional filament loops are extruded thermoplastic polymers. Examples of the thermoplastic polymer include, but are not limited to polyolefins, polystyrene-based thermoplastic elastomers, polyester-based thermoplastic elastomers, polyurethane-based thermoplastic elastomers, and polyamide-based thermoplastic elastomers. In a refinement, the thermoplastic polymer includes a linear low-density polyethylene. In another refinement, the thermoplastic polymer is a biodegradable or recyclable polymer (e.g., a “green” polymer).

In some refinement, the three-dimensional filament loops have a fineness from 200 to 10000 decitex. In a refinement, the three-dimensional filament loops have a fineness from 200 to 5000 decitex. In a further refinement, the three-dimensional filament loops have a fineness from 200 to 3000 decitex.

Examples of a method for forming and properties of a plurality of three-dimensional filament loops are disclosed in U.S. Pat. Nos. 10,233,073 and 9,918,559; the entire disclosures of which are hereby incorporated by reference in their entirety.

Advantageously, the seat vehicle seat cushion component 330 described above improves sustainability of current automotive seat components as well as provides support for occupants, improves the feeling of the extruded plastic mesh assembly and dampening qualities (related to sound and energy). In particular, the seat vehicle seat cushion component 330 provides sound deadening to any crunchy mesh material that may be added to the assembly, allows for aggressive contouring and shape for A-side features, and allows for multiple densities depending on layering (top and bottom can have separate densities, dependent on temperature), temperature buffering (insulation properties), and consistent hand feel.

Referring to FIGS. 20, 21A, and 21B, a vehicle seat 310 including the seat vehicle seat cushion component 330 described above is provided. Vehicle seat 310 includes a seat bottom 314 having a seat bottom frame 326 and a seat back 312 attached to the seat bottom 314. The seat back 312 includes a seat back frame 324. A vehicle seat cushion component 330 is attached to the seat back frame 324 and/or the bottom frame 326. As set forth above, the vehicle seat cushion component 330 includes a first bolster assembly 332. First bolster assembly 332 includes a first core cushion section 334 surrounded by a first outer bolster covering 336 of a first non-woven material. First bolster trim covering 338 surrounds first outer bolster covering 336. A second bolster assembly 340 includes a second core cushion section 342 surrounded by a second outer bolster covering 344 of a second non-woven material. Second bolster trim covering 348 surrounds second outer bolster covering 344. A trim covering section 350 includes a first edge 352 and a second edge 354. Characteristically, the first bolster assembly 332 is sewn to the trim covering section at the first edge 352 at sew line 356. Similarly, the second bolster assembly 340 is sewn to the trim covering section at the second edge 354 at sew line 358. In a variation, vehicle seat component 330 further includes a central cushion component 360 positioned in an opening 362 defined by the trim covering section 350.

A vehicle seat cushion component (e.g., 330) is described, which may be a seat bottom cushion, a seat back cushion, a head restraint, a headrest, a bolster, a region, and/or a portion. The vehicle seat cushion component (e.g., 330) comprises: a first bolster assembly (e.g., 332), which may be formed by compression molding, including a first core cushion section (e.g., 334), which may be foamed polyurethane, plurality of three-dimensional filament loops composed of a thermoplastic polymer, 60 to 95 volume percent air, density from about 0.01 to 0.200 g/cm³, surrounded by a first outer bolster covering (e.g., 336), which may be a non-woven fabric, natural fibers, and/or jute fibers, which is surrounded by a first bolster trim covering (e.g., 338), which may be a non-woven material, a biodegradable vegetable fiber, jute, an extruded thermoplastic resin material, one or more panels of a fabric, leather, leatherette, vinyl, and/or other material, a second bolster assembly (e.g., 340), which may be formed by compression molding, including a second core cushion section (e.g., 342), which may be foamed polyurethane, plurality of three-dimensional filament loops composed of a thermoplastic polymer, 60 to 95 volume percent air, density from about 0.01 to 0.200 g/cm³, surrounded by a second outer bolster covering (e.g., 344), which may be a non-woven fabric, natural fibers, and/or jute fibers, and a trim covering section (e.g., 350), which may be a non-woven material, a biodegradable vegetable fiber, jute, an extruded thermoplastic resin material, one or more panels of a fabric, leather, leatherette, vinyl, and/or other material, having a first edge and a second edge, the first bolster assembly (e.g., 332) being sewn to the trim covering section (e.g., 350) at the first edge and the second bolster assembly (e.g., 340) being sewn to the trim covering section (e.g., 350) at the second edge.

In some embodiments, the vehicle seat cushion component (e.g., 330) is included in a vehicle seat back or a vehicle seat bottom.

In some embodiments, the first bolster assembly (e.g., 332) and the second bolster assembly (e.g., 340) are each independently formed by compression molding, such as a layered/sandwiched assembly of Jute or nonwoven material and core cushion section, a top layer Jute/nonwoven fabric, a middle cushion section, and a bottom layer of Jute/nonwoven fabric.

In some embodiments, the first outer bolster covering (e.g., 336) and the second outer bolster covering (e.g., 344) each independently includes a non-woven fabric.

In some embodiments, the first outer bolster covering (e.g., 336) and the second outer bolster covering (e.g., 344) each independently include natural fibers.

In some embodiments, the vehicle seat cushion component (e.g., 330) further comprises a central cushion component (e.g., 360), which may be foamed polyurethane, a plurality of three-dimensional filament loops composed of a thermoplastic polymer, 60 to 95 volume percent air, and/or a density from about 0.01 to 0.200 g/cm³, positioned in an opening defined by the trim covering section.

In some embodiments, the first core cushion section (e.g., 334), the second core cushion section (e.g., 342), and the central cushion component (e.g., 360) are each independently composed of a foamed polyurethane, such as isocyanates, polyols, and a suitable blowing agent.

In some embodiments, the first core cushion section (e.g., 334), the second core cushion section (e.g., 342), and the central cushion component (e.g., 360) are each independently composed of a plurality of three-dimensional filament loops, which may be plurality of fused connections in which two loops are attached to each other, not parallel or aligned with each other, fineness from 200 to 10000 decitex, composed of a thermoplastic polymer, which may be polyolefins, polystyrene-based thermoplastic elastomers, polyester-based thermoplastic elastomers, polyurethane-based thermoplastic elastomers, polyamide-based thermoplastic elastomers, and/or biodegradable or recyclable polymer.

In some embodiments, the plurality of three-dimensional filament loops includes a plurality of fused connections in which two loops are attached to each other.

In some embodiments, at least a subset of loops in the plurality of three-dimensional filament loops are not parallel or aligned with each other.

In some embodiments, the first core cushion section (e.g., 334), the second core cushion section (e.g., 342), and the central cushion component (e.g., 360) are independently from 60 to 95 volume percent air.

In some embodiments, the first core cushion section (e.g., 334), the second core cushion section (e.g., 342), and the central cushion component (e.g., 360) each independently have a density from about 0.01 to 0.200 g/cm³.

In some embodiments, the thermoplastic polymer is an extruded thermoplastic polymer.

In some embodiments, the thermoplastic polymer is composed of a component selected from the group consisting of polyolefins, polystyrene-based thermoplastic elastomers, polyester-based thermoplastic elastomers, polyurethane-based thermoplastic elastomers, and polyamide-based thermoplastic elastomers.

In some embodiments, the thermoplastic polymer is a biodegradable or recyclable polymer.

In some embodiments, the plurality of three-dimensional filament loops has a fineness from 200 to 10000 decitex.

In some embodiments, the vehicle seat cushion component (e.g., 330) comprises providing sound deadening and temperature buffering.

A vehicle seat (e.g., 310) is disclosed, which may be a vehicle seat, office chair, individual chair, and/or the like. The vehicle seat (e.g., 310) comprises: a seat bottom having a seat bottom frame, which may be a stamped steel alloy, a fiber reinforced polymer, or any suitable structural material, wire suspension mats, a substrate, and/or a panel; a seat back attached to the seat bottom, the seat back including a seat back frame, which may be a stamped steel alloy, a fiber reinforced polymer, or any suitable structural material, wire suspension mats, a substrate, and/or a panel; and a vehicle seat cushion component (e.g., 330), which may be a seat bottom cushion, a seat back cushion, a head restraint, a headrest, a bolster, a region, and/or a portion, attached to the seat bottom frame and/or the seat back frame, the vehicle seat cushion component (e.g., 330) comprising: a first bolster assembly (e.g., 332), which may be formed by compression molding, including a first core cushion section (e.g., 334), which may be foamed polyurethane, plurality of three-dimensional filament loops composed of a thermoplastic polymer, 60 to 95 volume percent air, density from about 0.01 to 0.200 g/cm³, surrounded by a first outer bolster covering (e.g., 336), which may be a non-woven fabric, natural fibers, and/or jute fibers, which is surrounded by a first bolster trim covering (e.g., 338), which may be a non-woven material, a biodegradable vegetable fiber, jute, an extruded thermoplastic resin material, one or more panels of a fabric, leather, leatherette, vinyl, and/or other material; a second bolster assembly (e.g., 340)), which may be formed by compression molding, including a second core cushion section (e.g., 342), which may be foamed polyurethane, plurality of three-dimensional filament loops composed of a thermoplastic polymer, 60 to 95 volume percent air, density from about 0.01 to 0.200 g/cm³, surrounded by a second outer bolster covering (e.g., 344), which may be a non-woven fabric, natural fibers, and/or jute fibers, which is surrounded by a second bolster trim covering, which may be a non-woven material, a biodegradable vegetable fiber, jute, an extruded thermoplastic resin material, one or more panels of a fabric, leather, leatherette, vinyl, and/or other material; and a trim covering section, which may be a non-woven material, a biodegradable vegetable fiber, jute, an extruded thermoplastic resin material, one or more panels of a fabric, leather, leatherette, vinyl, and/or other material, having a first edge and a second edge, the first bolster assembly (e.g., 332) being sewn to the trim covering section at the first edge and the second bolster assembly (e.g., 340) being sewn to the trim covering section at the second edge.

In some embodiments, the first outer bolster covering (e.g., 336) and the second outer bolster covering (e.g., 344) each independently includes a non-woven fabric.

In some embodiments, the first outer bolster covering (e.g., 336) and the second outer bolster covering (e.g., 344) each independently include natural fibers.

In some embodiments, the vehicle seat cushion component (e.g., 330) further includes a central cushion component (e.g., 360), which may be foamed polyurethane, a plurality of three-dimensional filament loops composed of a thermoplastic polymer, 60 to 95 volume percent air, and/or a density from about 0.01 to 0.200 g/cm³, positioned in an opening defined by the trim covering section.

In some embodiments, the first core cushion section (e.g., 334), the second core cushion section (e.g., 342), and the central cushion component (e.g., 360) are each independently composed of a foamed polyurethane, such as isocyanates, polyols, and a suitable blowing agent.

In some embodiments, the first core cushion section (e.g., 334), the second core cushion section (e.g., 342), and the central cushion component (e.g., 360) are each independently composed of a plurality of three-dimensional filament loops, which may be plurality of fused connections in which two loops are attached to each other, not parallel or aligned with each other, fineness from 200 to 10000 decitex, composed of a thermoplastic polymer, which may be polyolefins, polystyrene-based thermoplastic elastomers, polyester-based thermoplastic elastomers, polyurethane-based thermoplastic elastomers, polyamide-based thermoplastic elastomers, and/or biodegradable or recyclable polymer.

In some embodiments, the plurality of three-dimensional filament loops includes a plurality of fused connection in which two loops are attached to each other.

In some embodiments, at least a subset of loops in the plurality of three-dimensional filament loops are not parallel or aligned with each other.

In some embodiments, the first core cushion section (e.g., 334) and the second core cushion section (e.g., 342) are from 60 to 95 volume percent air.

In some embodiments, the first core cushion section (e.g., 334) and the second core cushion section (e.g., 342) each independently a density from about 0.01 to 0.200 g/cm³.

In some embodiments, the thermoplastic polymer is an extruded thermoplastic polymer, which may be polyolefins, polystyrene-based thermoplastic elastomers, polyester-based thermoplastic elastomers, polyurethane-based thermoplastic elastomers, polyamide-based thermoplastic elastomers, and/or biodegradable or recyclable polymer.

The technique described above is optionally combined with one or more elements of the methods described above/below. For example, these parts can be used in conjunction with one or more methods 400, 1600, 1650, 1680, 2700, 3800.

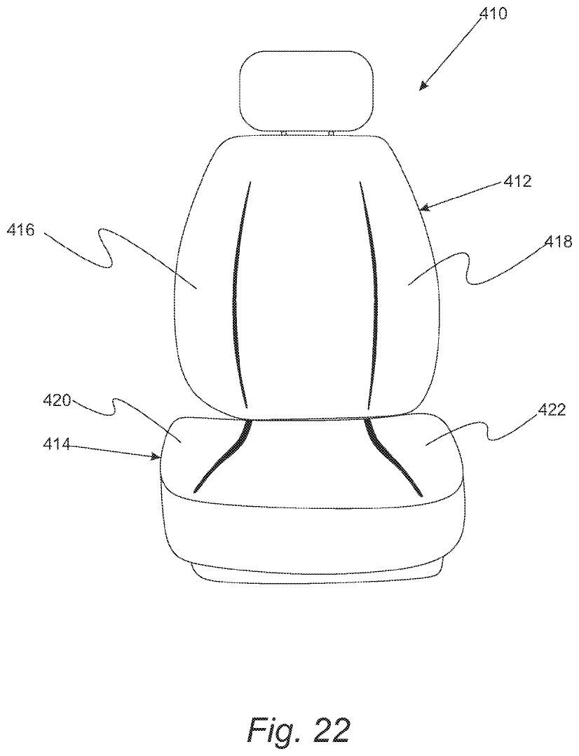

With reference to FIG. 22, a perspective view of a vehicle seat 410 having an extruded plastic mesh base is provided. Vehicle seat 410 includes seat back 412 and seat bottom 414. Seat back 412 includes right seat back bolster 416 and left seat back bolster 418. Seat bottom 414 includes right seat bottom bolster 420 and left seat bottom bolster 422.

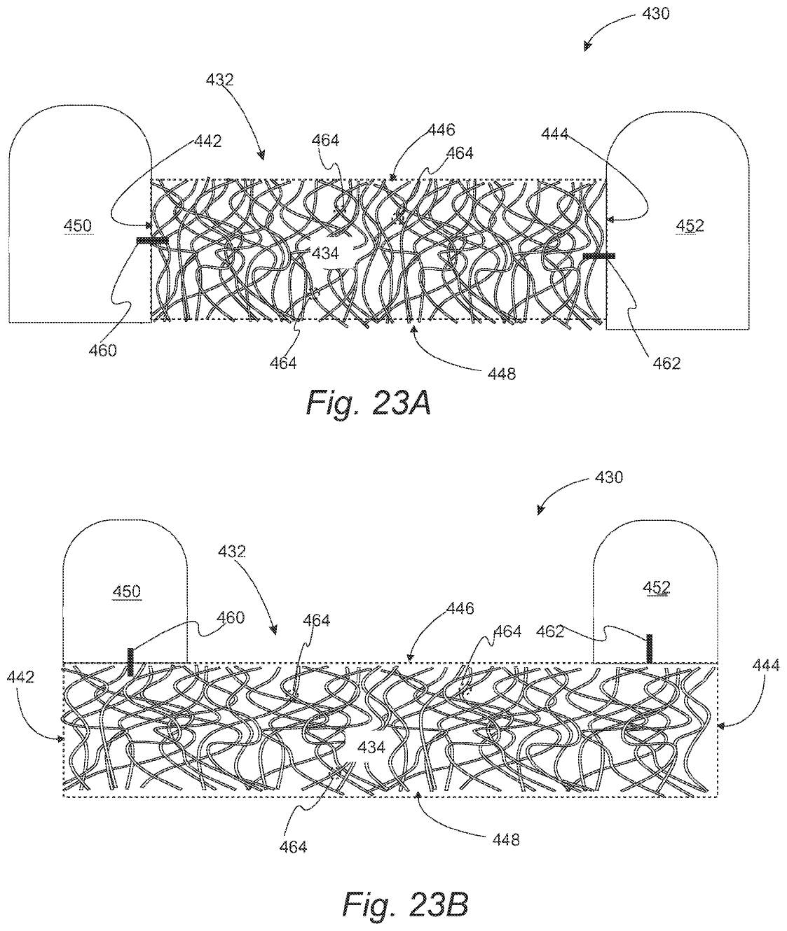

FIGS. 23A and 23B depict a cross-section of a vehicle seat component 430. Advantageously, the vehicle seat component 430 is a vehicle seat back or a vehicle seat bottom. Vehicle seat component 430 includes plastic mesh base 432. Plastic mesh base 432 includes a shaped plurality 434 of three-dimensional filament loops or strands composed of a thermoplastic polymer or resin. In this context, the plurality 434 of three-dimensional filament loops have a general block shape or any shape suitable to function as a cushion. Plastic mesh base 432 has a first edge 442, a second edge 444, a first face 446, and a second face 448. A first foamed bolster 450 is attached to the plastic mesh base at the first edge 442. A second foamed bolster 452 is attached to the plastic mesh base 432 at the second edge 444. FIG. 23A depicts a refinement in which the first foamed bolster 450 is attached to the first edge 442 and the second foamed bolster 452 is attached to the second edge 444 while FIG. 23B depicts a refinement in which the first foamed bolster 450 and the second foamed bolster 452 are each disposed over the first face 446.

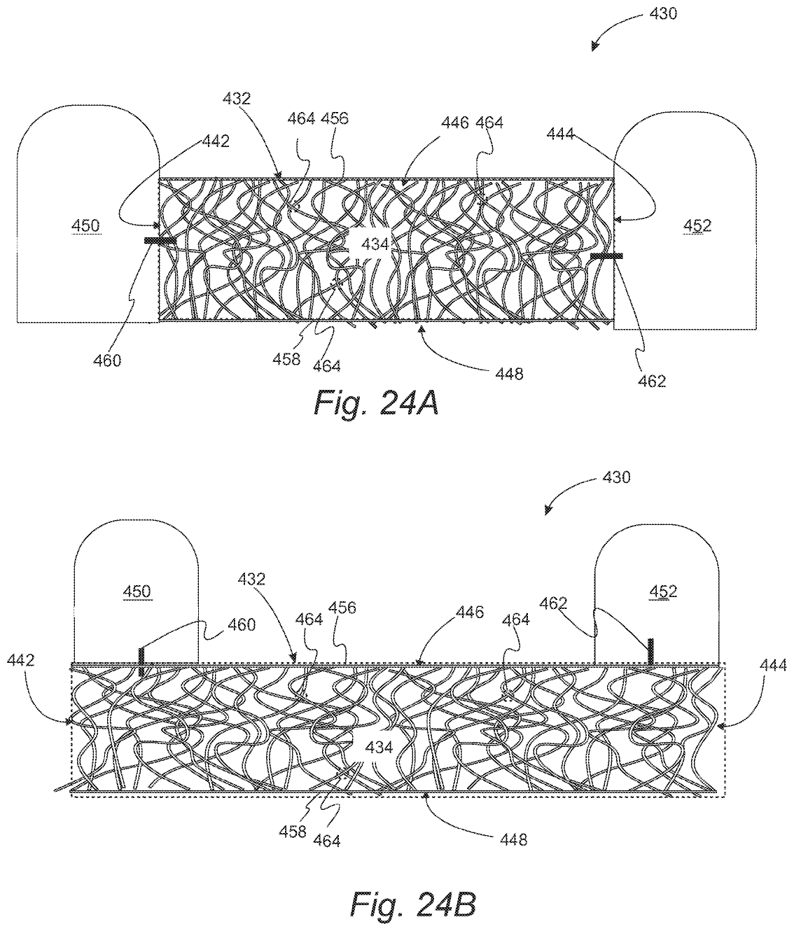

FIGS. 24A and 24B depict a cross-section of another variation of a cushion section of a vehicle seat. As set forth above, the vehicle seat component 430 is a vehicle seat back or a vehicle seat bottom. Vehicle seat component 430 includes plastic mesh base 432. Plastic mesh base 432 includes a shaped plurality of three-dimensional filament loops 434 or strands composed of a thermoplastic polymer or resin. Plastic mesh base 432 has a first edge 442, a second edge 444, a first face 446, and a second face 448. A first foamed bolster 450 is attached to the plastic mesh base 432 at the first edge 442. A second foamed bolster 452 is attached to the plastic mesh base 432 at the second edge 444. In this variation, optional skin layer 456 is disposed over and contacts the first face 446 of the shaped plurality 434 of three-dimensional filament loops 434. Optional skin layer 456 is disposed over and contacts the first face 446 of the shaped plurality 434 of three-dimensional filament loops. Vehicle seat component 430 can include one or both of skin layers 456 and 458.

Referring to FIGS. 23A, 23B, 24A, and 24B, the first foamed bolster 450 and the second foamed bolster 452 are each independently composed of a foamed polymer. In a refinement, the first foamed bolster 450 and the second foamed bolster 452 are each independently composed of a foamed polyurethane. As is known in the art, foamed polyurethanes are formed from the reaction of isocyanates, polyols, and a suitable blowing agent.

Referring to FIGS. 23A, 23B, 24A, and 24B, the first foamed bolster 450 is attached to the plastic mesh base 432 with a first retention clip 460, and the second foamed bolster 452 is attached to the plastic mesh base 432 with a second retention clip 462. The first retention clip 460 and the second retention clip 462 each independently have an end embedded in foam and a retention clip end attached to the plastic mesh base. An example of a retention clip is disclosed in U.S. patent application Ser. No. 17/724,866, filed on Apr. 20, 2022, the entire disclosure of which is hereby incorporated by reference.

Examples of a method for forming and properties of a plurality of three-dimensional filament loops are disclosed in U.S. Pat. Nos. 10,233,073 and 9,918,559; the entire disclosures of which are hereby incorporated by reference in their entirety.

Referring to FIGS. 23A, 23B, 24A, and 24B, at least a subset of loops in the plurality of three-dimensional filament loops are not parallel or aligned with each other. In a refinement, loops in the plurality of three-dimensional filament loops are randomly oriented, the plastic mesh base is from 60 to 95 volume percent air. In a refinement, the plastic mesh base has a density from about 0.01 to 0.200 g/cm³. In some refinement, the plurality of three-dimensional filament loops includes a plurality of fused connections 464 in which two loops are attached to each other.

In a variation, three-dimensional filament loops and the optional skin layers if present are composed of a thermoplastic polymer. In a refinement, the three-dimensional filament loops are an extruded thermoplastic polymer. Examples of the thermoplastic polymer include, but are not limited to polyolefins, polystyrene-based thermoplastic elastomers, polyester-based thermoplastic elastomers, polyurethane-based thermoplastic elastomers, and polyamide-based thermoplastic elastomers. In a refinement, the thermoplastic polymer includes linear a low-density polyethylene. In some refinement, the three-dimensional filament loops have a fineness from 200 to 10000 decitex. In a refinement, the three-dimensional filament loops have a fineness from 200 to 5000 decitex. In a further refinement, the three-dimensional filament loops have a fineness from 200 to 3000 decitex.

A vehicle seat cushion component (e.g., 430) is described, which may be a seat bottom cushion, a seat back cushion, a head restraint, a headrest, a bolster, a region, and/or a portion. The vehicle seat cushion component (e.g., 430) comprises: a plastic mesh base (e.g., 432), which may be an extruded thermoplastic resin mesh, strands, three-dimensional filament loops of an extruded, expanded thermoplastic resin or polymer, plurality of fused connections in which two loops are attached to each other, independently include from 60 to 95 volume percent air, density from about 0.01 to 0.200 g/cm³. The plastic mesh base (e.g., 432) comprises a plurality of three-dimensional filament loops, which at least a subset of loops in the plurality of three-dimensional filament loops may or may not be parallel or aligned with each other, may be randomly oriented, and may have a fineness from 200 to 10000 decitex. The three-dimensional filament loops are composed of a thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene. The plastic mesh base (e.g., 432) has a first edge, a second edge, a first face, which may be a skin layer, and a second face, which may be a skin layer. The vehicle seat cushion component (e.g., 430) comprises a first foamed bolster (e.g., 450), which may be foamed polymer, foamed polyurethane, isocyanates, polyols, and/or a suitable blowing agent, attached to the plastic mesh base (e.g., 432), with or without a retention clip having an end embedded in the foam, and a retention clip end attached to the plastic mesh base, hook and loop connector strips, hook layers, loop layers, adhesives, hog rings, single or double sided retention clips, bonded, welded, sewn, fastened, adhered, heat staked, and/or otherwise retained, at the first edge and a second foamed bolster (e.g., 452), which may be foamed polymer, foamed polyurethane, isocyanates, polyols, and/or a suitable blowing agent, attached to the plastic mesh base (e.g., 432) at the second edge.

In some embodiments, the vehicle seat cushion component (e.g., 430) is included in a vehicle seat back or a vehicle seat bottom.

In some embodiments, the plurality of three-dimensional filament loops includes a plurality of fused connections in which two loops are attached to each other, which may or may not be not parallel or aligned with each other, and/or randomly oriented.

In some embodiments, the first foamed bolster (e.g., 450) and the second foamed bolster (e.g., 452) are each independently composed of a foamed polymer, which may be a foamed polyurethane.

In some embodiments, the first foamed bolster (e.g., 450) and the second foamed bolster (e.g., 452) are each independently composed of a foamed polyurethane, which may be a foamed polymer, isocyanates, polyols, and/or a suitable blowing agent.

In some embodiments, the first foamed bolster (e.g., 450) and the second foamed bolster (e.g., 452) are each at least partially disposed over the first face.

In some embodiments, the first foamed bolster (e.g., 450) is attached to the first edge and the second foamed bolster (e.g., 452) is attached to the second edge.

In some embodiments, the first foamed bolster (e.g., 450) is attached to the plastic mesh base (e.g., 432) with a first retention clip and the first foamed bolster (e.g., 450) is attached to the plastic mesh base (e.g., 432) with a second retention clip, the first retention clip and the second retention clip each having an end embedded in the foam of the respective, first or second foamed bolster (e.g., 452), and a retention clip end attached to the plastic mesh base (e.g., 432).

In some embodiments, at least a subset of loops in the plurality of three-dimensional filament loops are not parallel or aligned with each other.

In some embodiments, loops in the plurality of three-dimensional filament loops are randomly oriented.

In some embodiments, the plastic mesh base (e.g., 432) is from 60 to 95 volume percent air.

In some embodiments, the plastic mesh base (e.g., 432) has a density from about 0.01 to 0.200 g/cm³.

In some embodiments, the thermoplastic polymer is an extruded thermoplastic polymer.

In some embodiments, the thermoplastic polymer includes a component selected from the group consisting of polyolefins, polystyrene-based thermoplastic elastomers, polyester-based thermoplastic elastomers, polyurethane-based thermoplastic elastomers, and polyamide-based thermoplastic elastomers.

In some embodiments, the thermoplastic polymer includes linear low-density polyethylene.

In some embodiments, the plurality of three-dimensional filament loops has a fineness from 200 to 10000 decitex.

A vehicle seat cushion component (e.g., 430) is disclosed, which may be a seat bottom cushion, a seat back cushion, a head restraint, a headrest, a bolster, a region, and/or a portion. The vehicle seat cushion component comprises a plastic mesh base (e.g., 432), which may be an extruded thermoplastic resin mesh, strands, three-dimensional filament loops of an extruded, expanded thermoplastic resin or polymer, plurality of fused connections in which two loops are attached to each other, independently include from 60 to 95 volume percent air, density from about 0.01 to 0.200 g/cm³, the plastic mesh base (e.g., 432) comprising a plurality of three-dimensional filament loops, which at least a subset of loops in the plurality of three-dimensional filament loops may or may not be parallel or aligned with each other, may be randomly oriented, and may have a fineness from 200 to 10000 decitex, the three-dimensional filament loops composed of a thermoplastic polymer, which may be 60 to 95 volume percent air, density from about 0.01 to 0.200 g/cm³, wherein each may be independently shaped into a form for a vehicle seat bolster, polyolefin, polystyrene-based thermoplastic elastomer, polyester-based thermoplastic elastomer, polyurethane-based thermoplastic elastomer, polyamide-based thermoplastic elastomer, and/or a linear low-density polyethylene.

In some embodiments, the vehicle seat cushion component (e.g., 430) is included in a vehicle seat back or a vehicle seat bottom.

In some embodiments, the plurality of three-dimensional filament loops includes a plurality of fused connections in which two loops are attached to each other.

In some embodiments, loops in the plurality of three-dimensional filament loops are randomly oriented.

In some embodiments, the plastic mesh base (e.g., 432) is from 60 to 95 volume percent air.

In some embodiments, the thermoplastic polymer includes a component selected from the group consisting of polyolefins, polystyrene-based thermoplastic elastomers, polyester-based thermoplastic elastomers, polyurethane-based thermoplastic elastomers, and polyamide-based thermoplastic elastomers.

The technique described above is optionally combined with one or more elements of the methods described above/below. For example, these parts can be used in conjunction with another method 400, 1600, 1650, 1680, 2700, 3800.

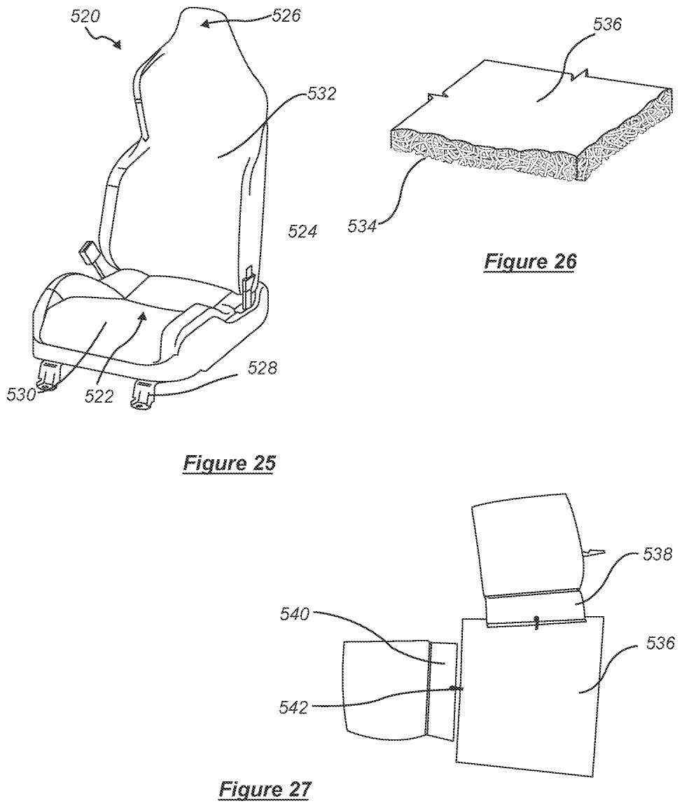

FIG. 25 illustrates a seat assembly 520 according to an embodiment. The seat assembly 520 is depicted as a vehicle seat, which may be employed as a seat assembly in a land vehicle, an aircraft, a watercraft, or the like. The seat assembly 520 may be employed within any row within the vehicle as an individual or a bench chair. Alternatively, the seat assembly 520 may also be employed as an office chair, or any other chair. The seat assembly 520 omits traditional foam to improve support and comfort. The seat assembly 520, optionally, also employs recycled materials, which are manufactured for further recycling at the end of use of the seat assembly 520.

The seat assembly 520 comprises a seat bottom 522, which is sized to receive a seated occupant to support a pelvis and thighs of the occupant. The seat assembly 520 also includes a seat back 524 sized to extend upright from the seat bottom 522 to support a back of the occupant. A head restraint (or headrest) 526 may also be supported upon and above the seat back 524 to support a head of the occupant. The seat bottom 522 is adapted to be supported by an underlying support surface. For the depicted embodiment, the seat assembly 520 includes a pair of rails 528 for mounting the seat bottom 522 to a vehicle floor for fore and aft adjustment relative to the vehicle floor. The seat back 524 may also be adjustable for recline relative to the seat bottom 522. While in the depicted embodiment, the head restraint 526 is shown as integrated, and uniform with, the seat back 524, in some embodiments it may be separate and as such adjustable in height, tilt, and fore/aft directions. Other adjustments may be provided, as are known in the art.

The seat bottom 522 may include a frame (not shown) for providing rigid structural support to the seat bottom 522. Similarly, the seat back 524 may also include a frame (not shown) connected to the seat bottom frame to extend upright from the seat bottom 522, and to provide rigid structural support to the seat back 524. In some embodiments, a single (one-piece) frame is, optionally, used for both the seat bottom 522 and the seat back 524 to provide a rigid structural support. These/this frame(s) are, optionally, formed from a stamped steel alloy, a fiber reinforced polymer, or any suitable structural material.

Conventional seating assemblies include a plurality of foam layers to collectively provide cushioning upon the frames. The foam layers vary in density to provide compliant support to the occupant while distributing forces from the occupant to the frames. The foam layers also provide comfort to the occupant. Yet, some foamless materials have been found to improve support, comfort, performance, and compactness while aiding potential recycling of the material at the end of use of the seat assembly. Accordingly, the present disclosure relates to a use of foamless material to provide cushioning upon the frames.

Still referring to FIG. 25, the seat bottom 522 and the seat back 524 of the seat assembly 520, optionally, further include one or more seat bottom cushions 530 and one or more seat back cushions 532. The one or more seat bottom cushions 530, the one or more seat back cushions 532, or both, may comprise foamless material. In some embodiments, the foamless material of the one or more seat bottom cushions 530, the one or more seat back cushions 532, or both is, optionally, one or more stranded-mesh material.

Referring now to FIG. 26, one of the seat bottom cushions 530 is partially illustrated disassembled from the seat assembly 520. The seat bottom cushion 530 which may, but need not, be the same as the one or more seat back cushions 532, may be formed from a plurality of strands 534 or loops of an extruded expanded thermoplastic resin. In some embodiments, the seat bottom cushion 530 is also, optionally, formed with or bonded to at least one layer (or film) 536 formed or bonded with the plurality of strands 534. The layer 536 may be bonded to the plurality of strands 534 as the thermoplastic resin cures or via other coupling means such as compression molding, adhesives, mechanical fasteners (e.g., clamps, hog rings, deflective angled, ribbed shank fasteners (also known as Christmas tree fasteners), hook and loop fasteners, etc.), sewing, or the like. In some embodiments, the layer 536 is, optionally, also extruded thermoplastic resin material, a non-woven material, or both. In an exemplary embodiment, the non-woven material of layer 536 optionally comprises jute, which is a biodegradable vegetable fiber.

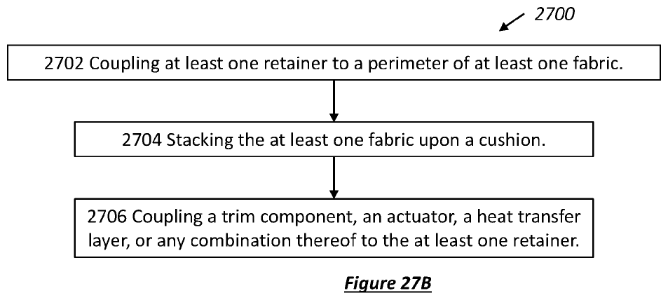

With reference to FIG. 27, the layer 536, optionally, provides surfaces for attaching other seating components 538, 540 by an adhesive, mechanical fasteners (e.g., clamps, hog rings, Christmas tree fasteners, hook and loop fasteners, etc.), or the like. In the depicted embodiment, the other seating components 538, 540 are attached to the layer 536 by clamp rings 542, also known as hog rings 542. These other seating components 538, 540 are, optionally, one or more of the following: a trim cover, an actuator such as an air bladder assembly, a heat transfer layer such as a heating mat, or the like.

For the depicted embodiment, the hog rings 542 attached to compression molded jute 536 and expanded thermoplastic resin mesh 534 provide satisfactory attachment that is resistant to tension. For example, this embodiment withstands tensile loads of at least 50 Newtons, and up to 151 Newtons, with deformation of at least 26 millimeters, and up to 44 millimeters.

Accordingly, a seat assembly comprising a seat bottom, a seat back, and a seat trim assembly is disclosed herein wherein the seat trim assembly is, optionally, in the seat bottom, the seat back, or both. The seat trim assembly disclosed herein, optionally, further includes at least one fabric sized to be displaced across a surface of a cushion and at least one retainer coupled to the at least one fabric, along a perimeter of the fabric, to receive a trim component. In some embodiments, the seat trim assembly further comprises the cushion which, optionally, comprises stranded-mesh material. Similarly, in some embodiments, the seat trim assembly further comprises a trim cover sized to at least partially enclose the cushion and the at least one fabric such that the trim cover is coupled to the at least one retainer. The at least one retainer may be directly or indirectly coupled to the cushion, trim component, or the trim cover.

The trim component of the seat trim assembly may be an actuator such as an air bladder assembly, a heat transfer layer such as a heating mat, or any combination thereof. The retainer of the seat trim assembly may be one or more of at least one clamped ring, hog ring, Christmas tree fasteners, hook and loop fasteners, the like, or any combination thereof. The at least one fabric of the seat trim assembly may be any non-woven material, fabric, textile, or any combination thereof. In some embodiments, the non-woven material of the at least one fabric further comprises jute.

In some embodiments of the present disclosure, a seat assembly comprising a seat bottom, a seat back, and a product formed by a method comprising the following steps is disclosed wherein the product may be in the seat bottom, seat back, or both. These steps are, optionally, coupling at least one retainer to a perimeter of at least one fabric, stacking the at least one fabric upon a cushion, and coupling a trim component to the at least one retainer. In some embodiments, the method further comprises compression molding the at least one fabric to a contour of a cushion before stacking the at least one fabric upon the cushion. In other embodiments, the at least one fabric may be coupled to the contour of the cushion before stacking the at least one fabric upon the cushion via adhesives, mechanical fasteners such as clamps, hog rings, Christmas tree fasteners, hook and loop fasteners, etc., or the like. The at least one retainer may be directly or indirectly coupled to the at least one retainer. In exemplary embodiments where the at least one retainer is a clamped ring, another step of the method is clamping the at least one clamped ring to the fabric. In some embodiments, the stacking of the at least one fabric upon the cushion further, optionally, comprises stacking the at least one fabric upon a stranded-mesh material cushion.

In some embodiments, the product formed by the aforesaid method further comprises coupling a trim cover sized to at least partially enclose the cushion and the at least one fabric, to the at least one retainer. In some exemplary embodiments, the trim component of the product formed by this method may be an actuator such as an air bladder assembly, a heat transfer layer such as a heating mat, or any combination thereof. The retainer of the product formed by the method may be at least one clamped ring, hog ring, Christmas tree fasteners, hook and loop fasteners, the like, or any combination thereof. The at least one fabric of the product formed by the method may be any non-woven material, fabric, textile, or any combination thereof. In some exemplary embodiments, the non-woven material of the at least one fabric further comprises jute.

According to other aspects of the present disclosure a trim assembly manufactured from the following method is disclosed. This method comprises coupling at least one retainer to a perimeter of at least one fabric, stacking the at least one fabric upon a cushion, and coupling a trim component such as an actuator, a heat transfer layer, or any combination thereof to the at least one retainer. In some embodiments, the method, optionally, further comprises at least partially enclosing the cushion and the at least one fabric by coupling a trim cover to the at least one retainer. The at least one retainer which may be directly or indirectly coupled to the at least one fabric, cushion, or trim component is, optionally, one or more of the at least one clamped ring, hog ring, Christmas tree fasteners, hook and loop fasteners, the like, or any combination thereof. The at least one fabric of the trim assembly manufactured by the aforementioned method may be any non-woven material, fabric, textile, or any combination thereof. In some embodiments, the non-woven material of the at least one fabric further comprises jute.

An assembly (e.g., seat assembly 520) is described, which may be a vehicle seat, office chair, individual chair, and/or the like. The assembly (e.g., 520) comprises at least one fabric, which may be non-woven material, biodegradable vegetable fiber, jute, and/or extruded thermoplastic resin material. The at least one fabric is sized to be displaced across a surface of a cushion (e.g., 530 and/or 532), which may be stranded-mesh material, loops of an extruded expanded thermoplastic resin, an extruded thermoplastic resin mesh, strands, three-dimensional filament loops of an extruded, expanded thermoplastic resin or polymer, plurality of fused connections in which two loops are attached to each other, independently include from 60 to 95 volume percent air, density from about 0.01 to 0.200 g/cm³. At least one retainer (e.g., 542) may be a clamped ring, not directly coupled to the cushion, a hog ring, a deflective angled, ribbed shank fastener, a hook and loop fastener, sewn, adhesive, weld, staked, connector strip, retention clip, clamp, barbed fastener, lamination, and/or compression molding, coupled to the at least one fabric, along a perimeter of the fabric, to receive a trim component (e.g., 538 and/540) which may be a trim cover, a non-woven material, a biodegradable vegetable fiber, jute, an extruded thermoplastic resin material, one or more panels of a fabric, leather, leatherette, vinyl, and/or other material, an actuator (e.g., 538 and/540), such as an air bladder assembly, a heat transfer layer (e.g., 538 and/540) such as a heating mat, or any combination thereof.

In some embodiments, the assembly comprises the cushion (e.g., 530 and/or 532).

In some embodiments, the cushion (e.g., 530 and/or 532) further comprises a stranded-mesh material, which may be an extruded thermoplastic resin mesh, strands, three-dimensional filament loops of an extruded, expanded thermoplastic resin or polymer, a plurality of fused connections in which two loops are attached to each other, independently include from 60 to 95 volume percent air, density from about 0.01 to 0.200 g/cm³, which at least a subset of loops in the plurality of three-dimensional filament loops may or may not be parallel or aligned with each other, may be randomly oriented, and may have a fineness from 200 to 10000 decitex.

In some embodiments, the assembly comprises a trim cover, which may be a non-woven material, a biodegradable vegetable fiber, jute, an extruded thermoplastic resin material, one or more panels of a fabric, leather, leatherette, vinyl, and/or other material, sized to at least partially enclose the cushion (e.g., 530 and/or 532) and the at least one fabric, wherein the trim cover is coupled to the at least one retainer.

In some embodiments, the at least one retainer (e.g., 542) comprises at least one clamped ring (e.g., 542).

In some embodiments, the at least one retainer (e.g., 542) is not directly coupled to the cushion (e.g., 530 and/or 532).

In some embodiments, the at least one fabric further comprises a non-woven material.

In some embodiments, the non-woven material further comprises jute.

A seat assembly is described, which may be a vehicle seat, office chair, individual chair, and/or the like. The seat assembly comprises a seat bottom, a seat back, and a seat trim assembly in the seat bottom or the seat back. The seat trim assembly may be a trim cover, a non-woven material, a biodegradable vegetable fiber, jute, an extruded thermoplastic resin material, one or more panels of a fabric, leather, leatherette, vinyl, and/or other material.

A product is described, which may be a seat bottom cushion, a seat back cushion, a head restraint, a headrest, a bolster, a region, and/or a portion. The product is formed by a method that comprises coupling at least one retainer (e.g., 542), which may be a clamped ring, not directly coupled to the cushion, a hog ring, a deflective angled, ribbed shank fastener, a hook and loop fastener, sewn, adhesive, weld, staked, connector strip, retention clip, clamp, barbed fastener, lamination, and/or compression molding, to a perimeter of at least one fabric, which may be non-woven material, biodegradable vegetable fiber, jute, and/or extruded thermoplastic resin material; stacking the at least one fabric upon a cushion (e.g., 530 and/or 532), which may be a stranded-mesh material, loops of an extruded expanded thermoplastic resin, an extruded thermoplastic resin mesh, strands, three-dimensional filament loops of an extruded, expanded thermoplastic resin or polymer, plurality of fused connections in which two loops are attached to each other, independently include from 60 to 95 volume percent air, with a density from about 0.01 to 0.200 g/cm³; and coupling (with or without a retainer, a clamped ring, not directly coupled to the cushion, hog rings, deflective angled, ribbed shank fasteners, hook and loop fasteners, sewn, adhesive, welds, staked, connector strips, retention clips, clamps, barbed fasteners, lamination, and/or compression molding,) a trim component, which may be a non-woven material, a biodegradable vegetable fiber, jute, extruded thermoplastic resin material, one or more panels of a fabric, leather, leatherette, vinyl, and/or other material, an actuator, which may be an air bladder assembly, a heat transfer layer, which may be a heating mat, or any combination thereof to the at least one retainer (e.g., 542).

In some embodiments, the method further comprises compression molding the at least one fabric to a contour of a cushion (e.g., 530 and/or 532) before stacking the at least one fabric upon the cushion (e.g., 530 and/or 532).

In some embodiments, the method further comprises coupling (with or without a retainer, clamped ring, not directly coupled to the cushion, hog rings, deflective angled, ribbed shank fasteners, hook and loop fasteners, sewn, adhesive, welds, staked, connector strips, retention clips, clamps, barbed fasteners, lamination, and/or compression molding,) a trim cover, which may be a non-woven material, a biodegradable vegetable fiber, jute, extruded thermoplastic resin material, one or more panels of a fabric, leather, leatherette, vinyl, and/or other material, sized to at least partially enclose the cushion (e.g., 530 and/or 532) and the at least one fabric, to the at least one retainer (e.g., 542).

In some embodiments, stacking the at least one fabric upon the cushion (e.g., 530 and/or 532) further comprises stacking the at least one fabric upon a stranded-mesh material cushion.

In some embodiments, the method further comprises not directly coupling the at least one retainer (e.g., 542) to the cushion (e.g., 530 and/or 532).

In some embodiments, the method further comprises clamping at least one clamped ring to the fabric as the at least one retainer (e.g., 542).

A seat assembly is described, which may be a vehicle seat, office chair, individual chair, and/or the like. The seat assembly comprises a seat bottom, a seat back, and the product of any of any of the preceding or successive techniques, in the seat bottom or the seat back.

FIG. 27B illustrates a method 2700 in accordance with some embodiments. Method 2700 is for coupling a retainer (e.g., 542), such as a clamped ring, not directly coupled to the cushion, hog rings, deflective angled, ribbed shank fasteners, hook and loop fasteners, sewn, adhesive, welds, staked, connector strips, retention clips, clamps, barbed fasteners, lamination, and/or compression molding, to fabric, which may be non-woven material, biodegradable vegetable fiber, jute, and/or extruded thermoplastic resin material. In various examples, method 2700 may have greater or fewer steps than described below, and various steps may be performed in another order, sequentially, or simultaneously.

Method 2700 includes coupling (2702) (with or without a retainer, a clamped ring, not directly coupled to the cushion, hog rings, deflective angled, ribbed shank fasteners, hook and loop fasteners, sewn, adhesive, welds, staked, connector strips, retention clips, clamps, barbed fasteners, lamination, and/or compression molding,) at least one retainer (e.g., 542) to a perimeter of at least one fabric, which may be non-woven material, biodegradable vegetable fiber, jute, and/or extruded thermoplastic resin material. Method 2700 includes stacking (2704) the at least one fabric upon a cushion (e.g., 530 and/or 532), which may be a stranded-mesh material, loops of an extruded expanded thermoplastic resin, an extruded thermoplastic resin mesh, strands, three-dimensional filament loops of an extruded, expanded thermoplastic resin or polymer, plurality of fused connections in which two loops are attached to each other, independently include from 60 to 95 volume percent air, with a density from about 0.01 to 0.200 g/cm³. Method 2700 includes coupling (2706) a trim component, which may be a non-woven material, a biodegradable vegetable fiber, jute, extruded thermoplastic resin material, one or more panels of a fabric, leather, leatherette, vinyl, and/or other material, an actuator, which may be an air bladder assembly, a heat transfer layer, which may be a heating mat, or any combination thereof to the at least one retainer (e.g., 542).

In some embodiments, method 2700 includes at least partially enclosing the cushion (e.g., 530 and/or 532) and the at least one fabric by coupling a trim cover, which may be a non-woven material, a biodegradable vegetable fiber, jute, extruded thermoplastic resin material, one or more panels of a fabric, leather, leatherette, vinyl, and/or other material, to the at least one retainer (e.g., 542).

In some embodiments, the at least one fabric further comprises a non-woven material.

A trim assembly is described, which may be a non-woven material, a biodegradable vegetable fiber, jute, extruded thermoplastic resin material, one or more panels of a fabric, leather, leatherette, vinyl, and/or other material. The trim assembly is manufactured from the method of any of the preceding or successive techniques.

The technique described above is optionally combined with one or more elements of the methods described above/below. For example, these parts can be used in conjunction with one or more methods 400, 1600, 1650, 1680, 3800.

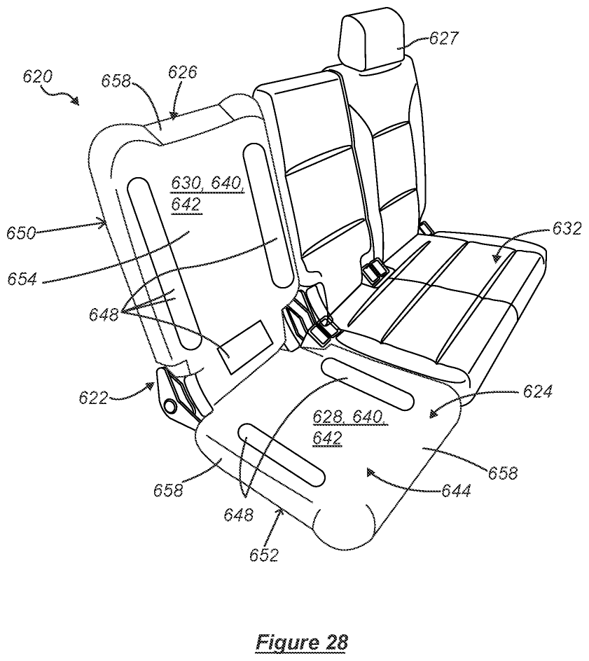

Referring to FIG. 28, a seat assembly 620, such as a vehicle seat assembly 620 is illustrated. In other examples, the seat assembly 620 may be shaped and sized as a front row driver or passenger seat, a second, third, or other rear row seat, and may include bench-style seats as shown, bucket seats, or other seat styles. Furthermore, the seat assembly 620 may be a non-stowable seat or a stowable seat that may be foldable and stowable in a cavity in the vehicle floor. Additionally, the seat assembly 620 may be configured for use with other non-vehicle applications.

The seat assembly 620 has a frame 622 or other support structure. The seat assembly has seat components, and these seat components include at least a seat bottom 624 and a seat back 626. The seat bottom 624 may be sized to receive a seated occupant to support a pelvis and thighs of the occupant. The seat back 626 may be sized to extend upright from the seat bottom 624 to support a back of the occupant. The seat assembly 620 may additionally have a head restraint 627, with the head restraint 627 illustrated for an adjacent seat assembly only.

The seat assembly 620 has a cushion 640 that defines a seat bottom cushion region 628 for the seat bottom 624, and a seat back cushion region 630 for the seat back 626. The frame 622 may include wire suspension mats or other structure to support the cushion 640. The cushion 640 is described in further detail below according to various examples and embodiments.

The frame 622 provides rigid structural support for the seat components, e.g., the cushion 640, the seat bottom 624 and seat back 626, and may be provided as multiple frame members that are moveable relative to one another to provide adjustments for the seat assembly. The frame may be formed from a stamped steel alloy, a fiber reinforced polymer, or any suitable structural material. The frame 622 may further include a substrate, e.g., a panel, to support the cushion 640.

One or more trim covers 632 are used to cover the cushion 640, and provide a seating surface 654 for the seat assembly 620. The vehicle seat assembly 620 is shown without a trim cover, and the adjacent seat assembly illustrates the trim cover 632. In one example, the trim cover 632 covers both of the cushion regions 628, 630. In other examples, multiple trim covers are provided to cover the seat bottom cushion region and the seat back cushion region. The trim cover 632 may be formed from one or more panels of a fabric, leather, leatherette, vinyl, or other material.

In the example shown, the seating cushion 640 includes at least one nonfoam component or member 642. In one example, and as shown, the seating cushion 640 is formed solely from the member 642, such that the nonfoam component 642 provides all of the cushioning for the seat component between the frame 622 and the trim cover 632. In other examples, the seating cushion 640 may be formed from the member 642 as well as one or more foam components, such as a component formed from molded polyurethane foam and/or one or more nonfoam components, such as secondary members 648 described below. The seating cushion 640 may have the nonfoam and foam components positioned to provide different regions of the cushion 640 for the seating component, e.g., a central region, and side bolster regions. Alternatively, or additionally, the seating cushion 640 may have a thin foam or other material layer positioned between the cushion 640 and the trim cover 632 to provide additional cushioning for one or more regions of the seating component. Furthermore, the seat assembly 620 may have a heating pad or heating mat positioned between the cushion 640 and the trim cover 632. By removing some or all of the traditional foam from the seating cushion 640, the seat assembly 620 may be provided with improved support and comfort, and reduced weight.

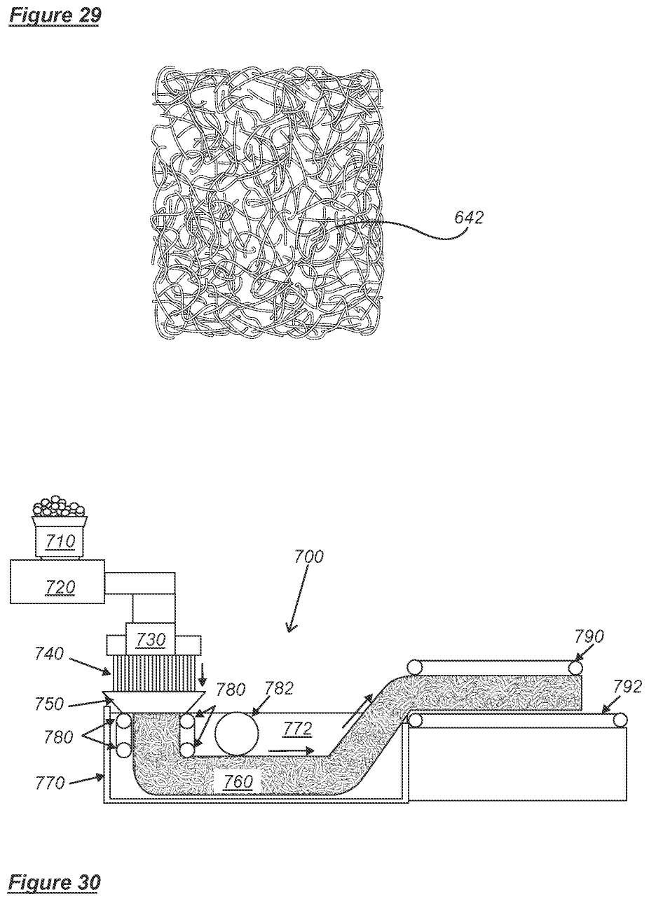

In one non-limiting example, the nonfoam component or member 642 of the seating cushion 640 is formed by a stranded mesh material, also known as an entangled three-dimensional filament structure. The stranded-mesh material is made from a polymeric mesh having a plurality of integrated polymeric strands. The stranded-mesh material may be made from, for example, a linear low-density polyethylene (LLPDE) material, although other polymers and materials effective to provide the desired properties and functionality are contemplated. The stranded-mesh material may be formed using extruded filaments of linear low-density polyethylene (LLDPE) that are randomly entangled, bent, looped, or otherwise positioned and oriented, and directly bonded to each other to provide a porous mesh structure, an example of which is shown in a closer view in FIG. 29.

Referring to FIGS. 28, 33 and 37, a member 642 is shown according to various embodiments. The member 642 may be used as a cushion for a seat assembly, such as the vehicle seat assembly 620, or in other non-vehicle or non-seating applications. The member 642 of the cushion 640 may be formed as a single integral component from the stranded mesh material, e.g., from a single extrusion as described below, and may be formed solely from the stranded mesh material. Furthermore, the stranded mesh material may include a polymeric mesh having a plurality of integrated polymeric strands as described above.

The member 642 defines a first end region 650 and a second end region 652 with the first and second end regions 650, 652 bounded by an outer perimeter of the member. In various examples, the first end region 650 is shaped to define or provide the seat back cushion region 630, and the second end region 652 is shaped to define or provide the seat bottom cushion region 628.

The member 642 also defines a first surface 654 to support an occupant on the cushion and a second surface 656 opposite to the first surface and spaced apart therefrom. The first surface 654 extends across the first and second end regions 650, 652, and the second surface 656 extends across the first and second end regions 650, 652. The first surface 654 is positioned on the seat assembly 620 to support an occupant of the seat assembly. A side surface 658 may extend around the perimeter of the member 642, and extend between the first and second surfaces 654, 656.

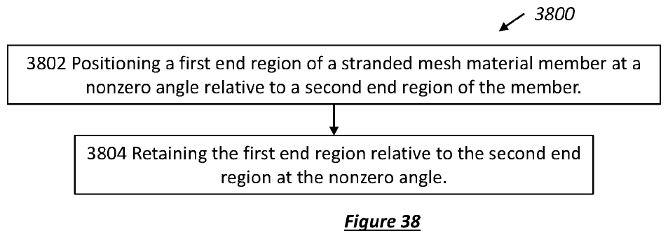

The member 642 is shown in a first position in FIGS. 32 and 36, and a second, use position as shown in FIGS. 28, 33, and 37. In FIGS. 28, 33, and 37, the member 642 has the first end region 650 positioned at a nonzero angle θ relative to the second end region 652. In one non-limiting example and as shown in FIGS. 33 and 37, the nonzero angle θ may lie within the range of 90-120 degrees, and furthermore, may lie within the range of 90-150 degrees. In other examples, other nonzero angle ranges may also be contemplated. In the first position, the member 642 is provided in the as-extruded shape, and furthermore, the first and second end regions 650, 652 may be oriented at a zero or substantially zero angle relative to one another. As used herein, substantially means within a range of five, ten, or fifteen degrees of the stated orientation. The member 642 may be bent, folded, curved, or otherwise oriented from the first position to the second position as further described below.

According to an example, the member 642 is shaped, curved, bent, or folded from the first position as shown in FIG. 32 to the second position as shown in FIG. 33. A transitional region 660 may be provided between the first and second end regions as shown.

According to another example, the member 642 may be formed or provided with one or more channels 662 that provide relief for shaping, curving, bending, or folding the member 642 from the first position to the second position. In the example shown, the one or more channels 662 are oriented to extend transversely across the member 642. The channels 662 may extend across the entire member 642, or only a portion thereof. In the example shown, the channels 662 intersect the first surface 654 of the member 642, and are provided as an open channel that does not intersect the second surface 656. In other examples, the channels may additionally or alternatively intersect the second surface 656 and/or a side surface 658. The channels 662 may be positioned between the first and second end regions 650, 652 of the member 642, e.g., in a transitional region 660 to provide relief for bending or shaping the member 642 from the first position to the second position.

In one example, each channel 662 has a first face 664 and a second face 672, and the channels 662 may be shaped with a V-shaped, U-shaped, or other cross-sectional shape when the member is in the first position. A V-shaped channel 662 is illustrated according to one non-limiting example. The first and second faces 664, 672 mate with one another, contact one another, or are otherwise moved towards one another when the member 642 is in the second position as shown in FIG. 37.

The first and second faces 664, 672 may be connected to one another to retain the member 642 in the second position as shown in FIG. 37. In one example, one or more channel fasteners 668 are provided to connect the first face 664 to the second face 672, and retain the member 642 in the second position. A channel fastener 668 may be provided by a hog ring, a hook and loop fastener, a barbed fastener, a clip, or the like. In another example, the first and second faces 664, 672 may be additionally or alternatively bonded to one another, e.g., via an adhesive, or via a lamination or welding process by melting strands on one face to strands on the other face.

In other examples, other channels may be additionally or alternatively formed or provided in the member 642 and extend in various directions, and furthermore may be positioned to intersect the second surface 656, a side surface 658, or multiple surfaces.

In various examples, the cushion 640 also includes one or more secondary members 648 that are supported by the member 642, as shown in FIGS. 28 and 34. These secondary members 648 may be provided from separate extrusions of stranded mesh material, other nonfoam materials, a foam such as molded polyurethan foam, or a combination thereof. The secondary members 648 may extend outwardly from the first surface 654 and/or the second surface 656 of the member 642, and may extend outwardly from the first end region 650 and/or the second end region 652. In one example, the secondary members 648 may form elements of the cushion 640 such as a side bolster or a lumbar pad or bolster.

The secondary members 648 may be connected to the connected to the member 642 to form the cushion 640. In one example, one or more secondary fasteners 670 are provided to connect the secondary member 648 to the member 642. A secondary fastener 670 may be provided by a hog ring, a hook and loop fastener, a barbed fastener, a clip, or the like. In another example, the secondary member 648 may be additionally or alternatively bonded to the member 642, e.g., via an adhesive, or via a lamination or welding process by melting strands on one face to strands on the other face.

Although secondary members 648 are only shown with respect to FIGS. 28 and 34, it is also envisioned that secondary members may be attached or otherwise supported by the member 642 of FIG. 37.

FIG. 30 illustrates a manufacturing process 700 to form a stranded mesh material member such as member 642 for the cushion 640 according to an embodiment.

A hopper 710 holds material stock that is to be extruded, e.g., as solid granules or pellets of the material. The material may be provided by plastic, such as a linear low-density polyethylene (LLDPE). The material is fed from the hopper 710 to an extruder 720.

The extruder 720 melts and transports the material to a die plate 730. In one non-limiting example, the extruder 720 includes a barrel that receives a rotatable screw, as well as heating elements. Rotation of the screw forces the material to move through the barrel and helps heat the material due to the friction generated as the screw rotates. The material exits the extruder 720 under pressure and in a molten state.

The die plate 730 extrudes the material into filaments 740. The die plate 730 may be provided as described below depending on the direction of the extrusion relative to the final member 642 produced from it. More specifically, the die plate 730 has multiple small, circular through holes or apertures through which the molten material passes. A single filament 740 is extruded from each die plate hole. The filaments 740 fall downward from the die plate under system pressure and the force of gravity to a funnel 750 as described below. The funnel 750 may have a cross-sectional shape that is the same as, or is different than a shape collectively defined by the apertures in the die plate.

The funnel 750 helps consolidate or group the filaments 740 into a more compact arrangement in which the filaments 740 bend or loop and each filament 740 contacts and bonds to at least one other filament 740. The funnel 750 has a funnel inlet and a funnel outlet that is smaller than the funnel inlet. The funnel 750 is narrower at the funnel outlet than at the funnel inlet. Individual separated filaments 740 enter the funnel inlet, the filaments 740 bend/loop and move into contact as they accumulate and slide down the funnel 750 toward the funnel outlet, and the consolidated filament structure 760 exits the funnel outlet and immediately enters a water tank. In various examples, the filament structure may slide down an angled surface of the funnel 750, thereby creating a material skin for the structure 760 that is formed from the equivalent of two to three rows of filaments adjacent to the perimeter of the structure 760.

A liquid tank 770 holds water 772 or another fluid, and receives the consolidated filament structure 760 from the funnel 750. The liquid 772 in the bath 770 helps temporarily support the consolidated filament structure 760 to prevent the filament structure from collapsing or condensing into a less open or less porous arrangement, and maintain the desired porosity and density. As such, the liquid 772 provides some resistance that causes additional bending, looping of the filaments 740 to further build the consolidated filament structure 760. Second, the liquid 772 cools the filaments 740 from the outside to solidify the filaments 740 and prevent the filaments 740 from bonding at additional locations.

The tank 770 includes various rollers and conveyors that help move the consolidated filament structure 760 through the liquid 772 and out of the liquid 772, such as a tractor conveyor 780. The rollers and conveyors speed may be controlled to move the consolidated filament structure 760 away from the funnel 750 at a speed that is dependent on the speed that the consolidated filament structure 760 exits the funnel 750.

Other rollers, such as roller 782 helps keep the consolidated filament structure 760 submerged in the liquid 772 and guides the consolidated filament structure 760 through the liquid 772 toward a conveyor belt 790 and shaker table 792 that are disposed outside of the tank 770. The shaker table 792 shakes the consolidated filament structure 760 while it is on the conveyor belt 790 to remove liquid 772. Pressurized air may additionally or alternatively be blown toward the consolidated filament structure 760, and/or the consolidated filament structure 760 may be squeezed to remove liquid 772.

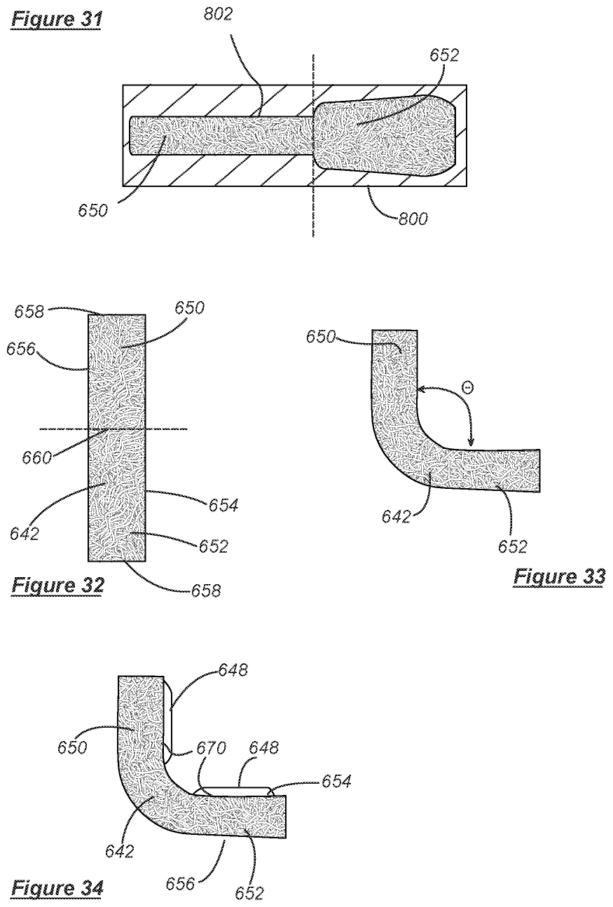

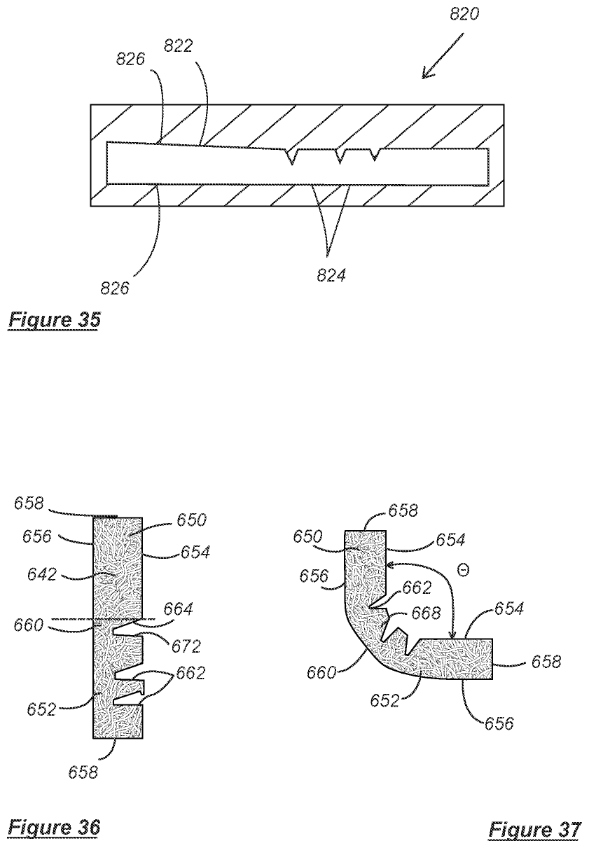

The consolidated filament structure 760 may then be cut to a desired size and shape. In one example, and for a die 730 or funnel 750 as shown in FIGS. 31, the cut across the consolidated filament structure 760 forms the first surface 654 or the second surface 656 of the member 642. In another example, and for a die 730 or funnel 750 as shown in FIG. 35, the cut across the consolidated filament structure forms a side surface 658 of the member 642.

Optionally, the member 642 may be further machined or cut to form channels, passages, or shapes in the member 642.

FIG. 31 illustrates a top view of a tool 800 such as a die 730 and/or funnel 750 for use with the manufacturing process 700 of FIG. 30, and according to an embodiment. FIG. 32 illustrates a side schematic view of a stranded mesh material member 642 in a first configuration or position and as provided by the tool 800 of FIG. 31. Note that the resulting member 642 may be seen in FIG. 28 for a perspective view according to one non-limiting example, and in the second position.

In one example, FIG. 31 illustrates a top view of the tool 800 as a die 730, with the filaments flowing down into the die 730. The apertures are arranged in a pattern as shown within the bounded perimeter 802 to form the first and second end regions 650, 652 of the member, e.g. the seat back and seat base cushion regions. The funnel 750 has a similar cross-sectional shape to that of the pattern formed by the die apertures.

For the resulting consolidated filament structure 760, the structure is cut such that the cut forms the first or second surface 654, 656 as described above, and the member 642 retains an outer perimeter shape as shown by the die and/or funnel pattern/perimeter 802. Furthermore, as the consolidated filament structure 760 is cut, e.g., across the page with reference to FIG. 31, the side surfaces 658 of the resulting member 642 are formed by the extruded consolidated filament structure 760. The thickness of the member 642, or length of the side surface 658, is therefore determined by where the consolidated filament structure 760 is cut.

FIG. 35 illustrates a top view of a tool 820 such as a die 730 and/or funnel 750 for use with the manufacturing process 700 of FIG. 30, and according to another embodiment. FIG. 36 illustrates a side schematic view of a stranded mesh material member 642 in a first configuration or position and as provided by the tool 820 of FIG. 31. Note that the resulting member 642 may be seen in FIG. 28 for a perspective view according to one non-limiting example, and in the second position.

In one example, FIG. 35 illustrates a top view of the tool 820 as a die 820, with the filaments flowing down into the die plate 730. The apertures are arranged in a pattern as shown within the bounded perimeter 822 to form the first and second end regions 650, 652 of the member, e.g., the seat back and seat base cushion regions, as well as the channels via region 824. The funnel 750 has a similar cross-sectional shape to that of the pattern formed by the die apertures, as well as the channels 62. The funnel 750 has a similar cross-sectional shape to that of the perimeter 822 formed by the die apertures. In other examples, only the funnel 750 forms region 824 to provide the channels in the filament structure, and the die 730 is without this structure.

For the resulting consolidated filament structure 760, the structure is cut such that the cut forms a side surface 658 as described above, and the member 642 retains cross-sectional shape as shown by the die pattern and/or funnel shape 822. Furthermore, as the consolidated filament structure 760 is cut, e.g., across the page with reference to FIG. 35, the first and second surfaces 654, 656 of the resulting member 642 are formed by the extruded consolidated filament structure, e.g., by edges 826, 828 of the die 730. The width of the member 642, or distance between the opposed side surfaces 658 on the left- and right-hand sides of the member 642, is therefore determined by where the consolidated filament structure 760 is cut.

In a further example, the die 730 and funnel 750 may be shaped to extrude the lengthwise, e.g., from top to bottom, and may include a region 824 to form channels that extend longitudinally along the member as opposed to transversely as described above. In this example, the first and second surfaces 654, 656, of the resulting member 642 are formed by the extruded consolidated filament structure 760. The length of the member 642, or distance between the top of the member 642 adjacent to the head restraint and opposed bottom of the member 642, is therefore determined by where the consolidated filament structure is cut and the side surfaces for the top and bottom of the member 642 are formed.

A method is provided, and may be used to form the member 642, assemble the cushion 640, and assemble the seat assembly 220. In various examples, the method may have greater or fewer steps than described below, and various steps may be performed in another order, sequentially, or simultaneously.

The member 642 is formed using a stranded mesh material, for example, via the process as described above with respect to FIG. 30. The stranded mesh material may be formed by extruding material through a die 730 to form the first and second end regions 650, 652 of the member, funneling the extruded material from the die through a funnel 750, and moving the extruded material after the funnel via one or more rollers 680, 682.

Furthermore, one or more channels 662 may be formed during at least one of extruding the material, funneling the extruded material, and moving the extruded material. Alternatively, the channels 662 may be formed in the member 642 after the consolidated filament structure 760 is cut to form the member.

The extruded material, or consolidated filament structure 760, is cut to form at least one outer surface of the member. The outer surface may extend across the first and second end regions 650, 652, and may be the first surface 654, the second surface 656, or a side surface 658. When the member 642 is cut from the consolidated filament structure 760, the member 642 is in the first position as is shown in FIGS. 32 and 36. The member 642 may further be machined or otherwise process to form other features, such as channels or passages for use in connecting trim assembly, or for positioning or receiving various components or systems of the seat assembly.

The first end region 650 of a stranded mesh material member 642 is oriented at a nonzero angle relative to a second end region 652 of the member to move the member from the first position to a second position as shown in FIGS. 33 and 37. In one example, the stranded mesh material member 642 is bent or curved from a first position to a second position to orient the member. Channels 662, if any are provided, may provide relief or locations for the bends or curves.

The first end region 650 is retained relative to the second end region 652 at the nonzero angle, and with the member 642 in the second position. In various examples, one or more channel fasteners 668 are inserted into opposed sides or faces 664, 672 of the channel, the opposed sides 664, 672 of the channel are bonded together, or a combination of the two are used to retain the first end region 650 relative to the second end region 652 in the second position.

One or more secondary members 648 are formed. The secondary members 648 may be formed from a stranded mesh material similar to that described above with respect to the process in FIG. 30 and shown in FIG. 29, and separately from the member 642. Alternatively, the secondary members 648 may be formed as other nonfoam or foam members. The secondary members 648 are attached to the member 642. The secondary members 648 may be attached to the member 642 when the member 642 is in the first position and/or the second position. The secondary members 648 may further be attached to the first surface 654, the second surface 656, and/or a side surface 658 of the member 642. In various examples, one or more secondary fasteners 670 are inserted into the secondary member 648 and the member 642, the secondary member 648 is bonded to the member 642, or a combination of the two are used to retain the secondary member 648 to the member 642.

The member 642 is attached to a frame 622 of a seat assembly to provide a cushion 640 therefor. A trim cover 632 may be positioned over the member 642 and cushion 640. The trim cover 632 may be connected to the cushion 640 and/or the frame 622.

Various embodiments provide for a single extrusion of the member 642 to create the general area for the cushion 640, including the seat back 626 and seat bottom 624. By further including channels 662 and/or secondary members 648, the desired shape of the cushion 640 is provided, while retaining the ease of a single extrusion.

Seat assemblies, seats, or chairs may be used herein to refer generally to an assembly which incorporates the teachings of one or more embodiments disclosed herein, which may include any combination of embodiments, or features of embodiments disclosed herein. Similarly, the terms: seat assembly, seat, or chair may refer to the same or similar assemblies. Seat bottoms, backs, bases, head restraints, headrests, or bolsters may be used herein to refer generally to any component, region or portion of a seat assembly, vehicle seat, or chair. Layers, sheets, substrates, portions, sections, regions, or segments may refer to any planar, non-planar, shaped, or contoured portion or region of a seat bottom, back, base, head restraint, headrest, or bolster formed from any disclosed material or combination of materials to provide a comfort and/or structure for the seat bottom, back, base, head restraint, headrest, or bolster. Bonded, connected, welded, sewn, fastened, retained, adhered, attached, coupled, or staked may refer to any manufacturing method or process for connecting components with or without fasteners, retainers, adhesives, welds, hog rings, connector strips, retention clips, hook and loop fasteners, clamps, deflective angled ribbed shank fasteners, barbed fasteners, lamination, compression molding, or additional trim components. Filaments, strands, bends, or loops may be used herein to refer to the generally linear polymeric units (although they may be looped, fused or bonded together to form a mesh-like structure) after being dispensed through one or more orifices of the die, plate, die plate, tool, tooling plate, extrusion die, or breaker plate, or other variations thereof, which are likewise used to refer to equivalent components. Similarly, the terms: consolidated filament structure, filament structure, entangled filament structure, yield strands, body, mesh, final member, nonfoam component, non-woven mesh, foamless material, support, component, core, member, extruded material, cushioning, cushion, or cushion component may refer to the same or similar components. The term funnel and cover may be used to refer to the same or similar components as well. The description herein may also use various terms to refer to a hole such as hole, orifice, nozzles, aperture, etc. In yet another example, tank, water tank, cooling chamber, liquid tank, and bath may refer to the same or similar components. The use of different terms to refer to the same or similar components may be used to avoid confusion when describing different preferred embodiments. The terms may be interchangeable as various components of features from various embodiments may be combined in manners not expressly described herein. This does not detract from the fact that certain terms may provide inherent detail not included by other interchangeable term(s) unless expressly stated otherwise (e.g., water tank and liquid tank refer to similar interchangeable components although in at least one preferred embodiment, the tank is filled with water or arranged to be filled with water as opposed to any liquid when water tank is used).

A cushion (e.g., 640) is described, which may be seat bottom cushion, seat back cushion, head restraint, headrest, bolster, region, portion. The cushion (e.g., 640) comprises a member (e.g., 642), which may be foam, non-foam, and/or a combination thereof. The member (e.g., 642) comprises a stranded mesh material, which may be a polymeric mesh having a plurality of integrated polymeric strands, entangled three-dimensional filament structure, linear low-density polyethylene, extruded filaments, randomly entangled, bent, looped, or otherwise positioned and oriented, and/or directly bonded to each other to provide a porous mesh structure. The member (e.g., 642) defines a first end region (e.g., 650), which may be shaped to define a seat back cushion, and a second end region (e.g., 652), which may be shaped to define a seat base cushion. The first (e.g., 650) and second (e.g., 652) end regions are bounded by an outer perimeter of the member (e.g., 642). The first end region (e.g., 650) is positioned (bent, folded, curved, and/or oriented) at a nonzero angle (such as 90-120 degrees, or 90-150 degrees) relative to the second end region (e.g., 652).

In some embodiments, the member (e.g., 642) is formed solely from the stranded mesh material.

In some embodiments, the stranded mesh material comprises a polymeric mesh having a plurality of integrated polymeric strands.

In some embodiments, the first end region (e.g., 650) is shaped to define a seat back cushion; and wherein the second end region (e.g., 652) is shaped to define a seat base cushion.

In some embodiments, the member (e.g., 642) further comprises a first surface to support an occupant on the cushion (e.g., 640) and a second surface opposite to the first surface, the first surface extending across the first (e.g., 650) and second (e.g., 652) end regions, the second surface extending across the first and second end regions.

In some embodiments, the member (e.g., 642) defines one or more channels, which may be V-shaped, U-shaped, and/or provide relief for shaping, curving, bending, or folding, each channel intersecting one of the first surface and the second surface, which may extend transversely, and/or intersect a side surface.

In some embodiments, the channel extends transversely across the member (e.g., 642) and is positioned between the first end region (e.g., 650) and the second end region (e.g., 652).

In some embodiments, the channel comprises a first face and a second face, wherein the first and second faces are mated with one another.

In some embodiments, the cushion (e.g., 640) further comprises one or more channel fasteners (e.g., 668) connecting the first face to the second face to retain the first end region (e.g., 650) at the nonzero angle relative to the second end region (e.g., 652).

In some embodiments, one or more secondary members (e.g., 648), such as a bolster or lumbar, supported by the member (e.g., 642).

In some embodiments, the secondary member (e.g., 648) comprises a stranded mesh material.

In some embodiments, the secondary member (e.g., 648) extends outwardly from at least one of the first end region (e.g., 650) and the second end region (e.g., 652) of the member (e.g., 642).

In some embodiments, the cushion (e.g., 640) further comprises one or more secondary member (e.g., 648) fasteners, which may be a hog ring, a hook and loop fastener, a barbed fastener, a clip, adhesive, lamination, and/or a weld, connecting the secondary member (e.g., 648) to the member (e.g., 642).

In some embodiments, the secondary member (e.g., 648) is shaped and positioned on the member (e.g., 642) to form a side bolster or a lumbar pad.

A seat assembly is described, which may be a vehicle seat, an office chair, and/or an individual chair. The seat assembly comprises: a frame, which may be a stamped steel alloy, a fiber reinforced polymer, and/or any suitable structural material, wire suspension mats, substrate, and/or panel, and the cushion (e.g., 640) according to any of the preceding or successive techniques. The cushion (e.g., 640) is supported by the frame.

A tool is described. The tool comprises: a die (e.g., 730) (or funnel) defining a series of apertures arranged to extrude material for the stranded mesh material member for the cushion (e.g., 640) according to any of the preceding or successive techniques. The series of apertures are arranged to define the outer perimeter of the member (e.g., 642) containing a seat back region and a seat base region.

In some embodiments, the series of apertures are further arranged such that the outer perimeter defines one or more channels for the member (e.g., 642).

In some embodiments, the series of apertures are arranged such that the one or more channels are positioned between the seat back region and the seat base region.

FIG. 38 illustrates a method 3800 in accordance with some embodiments. Method 3800 is for positioning (such as bent, folded, curved, and/or oriented) stranded mesh material members, which may be a polymeric mesh having a plurality of integrated polymeric strands, an entangled three-dimensional filament structure, linear low-density polyethylene, extruded filaments, randomly entangled, bent, looped, or otherwise positioned and oriented, and/or directly bonded to each other to provide a porous mesh structure. In various examples, method 3800 may have greater or fewer steps than described below, and various steps may be performed in another order, sequentially, or simultaneously.

Method 3800 comprises: positioning (3802) (such as bent, folded, curved, and/or oriented) a first end region (e.g., 650), which may be shaped to define a seat back cushion, of a stranded mesh material member (e.g., 642), which may be a polymeric mesh having a plurality of integrated polymeric strands, entangled three-dimensional filament structure, linear low-density polyethylene, extruded filaments, randomly entangled, bent, looped, or otherwise positioned and oriented, and/or directly bonded to each other to provide a porous mesh structure, at a nonzero angle (such as 90-120 degrees, and/or 90-150 degrees) relative to a second end region (e.g., 652) of the member (e.g., 642); and retaining (3804) with or without a hog ring, a hook and loop fastener, a barbed fastener, a clip, adhesive, lamination, and/or a weld, the first end region (e.g., 650) relative to the second end region (e.g., 652) at the nonzero angle.

In some embodiments, method 3800 includes forming the stranded mesh material member (e.g., 642) by extruding material through a die.

In some embodiments, the stranded mesh material member (e.g., 642) is extruded to form the first end region (e.g., 650) and the second end region (e.g., 652).

In some embodiments, forming the stranded mesh material member (e.g., 642) further comprises funneling the extruded material from the die through a funnel.

In some embodiments, method 3800 includes moving the extruded material after the funnel via one or more rollers.

In some embodiments, method 3800 includes forming (which may be by extruding, die cut, robotic laser cutting, waterjet cutting, laser cutting, and/or other flexible automation,) one or more channels during at least one of extruding the material, funneling the extruded material, and moving the extruded material.

In some embodiments, method 3800 includes cutting (which may be by die cutting, robotic laser cutting, waterjet cutting, laser cutting, and/or other flexible automation,) the one or more channels into the member (e.g., 642).

In some embodiments, method 3800 includes inserting one or more fasteners such as a hog ring, a hook and loop fastener, a barbed fastener, a clip, adhesive, lamination, and/or a weld, into opposed sides of the channel and/or bonding the opposed sides of the channel to retain the first end region (e.g., 650) relative to the second end region (e.g., 652).

In some embodiments, method 3800 includes cutting (which may be by die cutting, robotic laser cutting, waterjet cutting, laser cutting, and/or other flexible automation,) the extruded material to form an outer surface of the member (e.g., 642), the outer surface extending across the first (e.g., 650) and second (e.g., 652) end regions.

In some embodiments, method 3800 includes bending the stranded mesh material member (e.g., 642) from a first position to a second position to orient the member (e.g., 642).

In some embodiments, method 3800 includes attaching, which may be with a hog ring, a hook and loop fastener, a barbed fastener, a clip, adhesive, lamination, and/or a weld, one or more secondary members (e.g., 648) to the member (e.g., 642).

In some embodiments, method 3800 includes forming, such as by extruding, the secondary member (e.g., 648) from a stranded mesh material.

In some embodiments, attaching the secondary member (e.g., 648) to the member (e.g., 642) further comprises inserting one or more fasteners, which may be a hog ring, a hook and loop fastener, a barbed fastener, a clip, adhesive, lamination, and/or a weld, into the secondary member (e.g., 648) and the member (e.g., 642) and/or bonding the secondary member (e.g., 648) to the member (e.g., 642).

In some embodiments, method 3800 further comprises attaching the member (e.g., 642) to a frame, such as a stamped steel alloy, a fiber reinforced polymer, or any suitable structural material, wire suspension mats, substrate, and/or panel, of a seat assembly to provide a cushion (e.g., 640) therefor.

The technique described above is optionally combined with one or more elements of the methods described above. For example, these parts can be used in conjunction with another method 400, 1600, 1650, 1680, 2700.

Clause 1. A seat support, in combination with, or without, any of the successive clauses, comprising a plurality of flat layers to mount to a seat frame and to support an occupant upon the seat frame, wherein the plurality of flat layers is stacked upon one another, and each of the plurality of stacked layers has a varying density.

Clause 2. The seat support of any of the preceding or successive clauses, wherein the plurality of stacked layers varies in sequentially increasing density from an occupant support surface to a base layer.

Clause 3. The seat support of any of the preceding or successive clauses, wherein the plurality of stacked layers varies in sequentially increasing firmness from an occupant support surface to a base layer.

Clause 4. The seat support of any of the preceding or successive clauses, wherein the plurality of stacked layers is connected together.

Clause 5. The seat support of any of the preceding or successive clauses, wherein each sequential pair of the plurality of stacked layers are bonded together.

Clause 6. The seat support of any of the preceding or successive clauses, wherein each sequential pair of the plurality of stacked layers are welded, sewn, fastened, or adhered together.

Clause 7. The seat support of any of the preceding or successive clauses, wherein the plurality of stacked layers further comprises rubber, carpet, needled cotton shoddy, polyethylene terephthalate, or polypropylene.

Clause 8. The seat support of any of the preceding or successive clauses, wherein the plurality of stacked layers further comprises a base layer adapted to mount to the seat frame, wherein the base layer is formed from a denser material than the other layers of the plurality of stacked layers.

Clause 9. The seat support of any of the preceding or successive clauses, wherein the base layer is formed from an elastomeric material.

Clause 10. The seat support of any of the preceding or successive clauses, wherein the base layer is formed from an ethylene propylene diene monomer rubber, a thermoplastic polyurethane, or an expanded polyvinylchloride.

Clause 11. The seat support of any of the preceding or successive clauses, wherein the base layer has a thickness of two millimeters or less.

Clause 12. A seat assembly comprising: a substrate adapted to be mounted to a seat frame; and the seat support of any of the preceding or successive clauses, stacked upon the substrate.

Clause 13. The seat assembly of any of the preceding or successive clauses, wherein the substrate is formed from an elastomeric material.

Clause 14. The seat assembly of any of the preceding or successive clauses, wherein the substrate is formed from an ethylene propylene diene monomer rubber, a thermoplastic polyurethane, or an expanded polyvinylchloride.

Clause 15. The seat assembly of any of the preceding or successive clauses, further comprising a seat frame, wherein the substrate is attached to the seat frame.

Clause 16. A seat support, in combination with, or without, any of the preceding or successive clauses, comprising a plurality of flat layers to mount to a seat frame and to support an occupant upon the seat frame, wherein the plurality of flat layers is stacked upon one another, and wherein the plurality of stacked layers varies in sequentially increasing density from an occupant support surface to a base layer.

Clause 17. A method, in combination with, or without, any of the preceding or successive clauses, for manufacturing a seat assembly comprising: unrolling a first sheet of a first material; cutting a first seat support layer from the first sheet; installing the first seat support layer upon a substrate; unrolling a second sheet of a second material with a density less than that of the first material; cutting a second seat support layer from the second sheet; and installing the second seat support layer upon the first seat support layer.

Clause 18. The method of any of the preceding or successive clauses, further comprising: unrolling a third sheet of a third material with a density less than that of the second material; cutting a third seat support layer from the third sheet; and installing the third seat support layer upon the second seat support layer.

Clause 19. The method of any of the preceding or successive clauses, further comprising bonding the second seat support layer to the first seat support layer.

Clause 20. A seat assembly manufactured from the method of any of any of the preceding or successive clauses.

Clause 21. A seat support, in combination with, or without, any of the preceding or successive clauses, comprising a plurality of layers of an extruded thermoplastic resin mesh to mount to a seat frame and to support an occupant upon the seat frame, wherein the plurality of layers is stacked upon each other.

Clause 22. The seat support of any of the preceding or successive clauses, wherein at least one of the plurality of stacked layers has a generally uniform thickness.

Clause 23. The seat support of any of the preceding or successive clauses, wherein each of the plurality of stacked layers has a generally uniform thickness.

Clause 24. The seat support of any of the preceding or successive clauses, wherein the seat support further comprises at least two stacked layers.

Clause 25. The seat support of any of the preceding or successive clauses, wherein each of the plurality of stacked layers are pivotally connected to each other.

Clause 26. The seat support of any of the preceding or successive clauses, wherein at least one recess is formed into one of the plurality of stacked layers to provide the pivotal connection.

Clause 27. The seat support of any of the preceding or successive clauses, wherein each of the plurality of stacked layers are formed integrally.

Clause 28. A seat assembly comprising: a seat frame; and the seat support of any of the preceding or successive clauses, attached to the seat frame.

Clause 29. A seat support, in combination with, or without, any of the preceding or successive clauses, comprising a plurality of layers to mount to a seat frame and to support an occupant upon the seat frame, wherein the plurality of layers is stacked upon each other; wherein at least one of the plurality of stacked layers has a generally uniform thickness; wherein each of the plurality of stacked layers are formed integrally; and wherein each of the plurality of stacked layers are pivotally connected to each other.

Clause 30. A method of manufacturing a product in combination with, or without, any of the preceding or successive clauses, comprising: forming a plurality of cushion segments from an extruded thermoplastic resin mesh; and stacking the plurality of cushion segments as a cushion.

Clause 31. The method of any of the preceding or successive clauses further comprising shaping the plurality of cushion segments.

Clause 32. The method of any of the preceding or successive clauses, further comprising forming the plurality of cushion segments as an integral sheet.

Clause 33. The method of any of the preceding or successive clauses, further comprising folding the cushion segments to stack the cushion segments upon one another.

Clause 34. The method of any of the preceding or successive clauses, further comprising forming at least one recess in at least one of the plurality of cushion segments to fold the cushion segments.

Clause 35. The method of any of the preceding or successive clauses, further comprising cutting the plurality of cushion segments to shape the plurality of cushion segments.

Clause 36. A seat support manufactured from any of the preceding or successive clauses.

Clause 37. The method of any of the preceding or successive clauses, further comprising installing the product to a seat frame.

Clause 38. A seat assembly manufactured by the method of any of the preceding or successive clauses.

Clause 39. A method for designing a seat cushion in combination with, or without, any of the preceding or successive clauses, the method comprising: obtaining a design of a unitary seat cushion; and redesigning the unitary seat cushion design into a plurality of stacked cushion segment designs.

Clause 40. The method of any of the preceding or successive clauses further comprising redesigning the unitary seat cushion design into the plurality of stacked cushion segment designs each with a common maximum thickness.

Clause 41. A method of manufacturing a seat cushion, the method comprising: designing a plurality of cushion segment designs according to any of the preceding or successive clauses; and forming the plurality of cushion segments from an extruded thermoplastic resin mesh.

Clause 42. The method of any of the preceding or successive clauses, further comprising stacking the plurality of cushion segments as a cushion.

Clause 43. A vehicle seat cushion component in combination with, or without, any of the preceding or successive clauses, comprising: a first plastic mesh bolster including a first plurality of three-dimensional filament loops composed of a first thermoplastic polymer; a second plastic mesh bolster including a second plurality of three-dimensional filament loops composed of a second thermoplastic polymer; and a plastic mesh base including a third plurality of three-dimensional filament loops composed of a third thermoplastic polymer, the plastic mesh base having a first edge, a second edge, a first face, and a second face, wherein the first plastic mesh bolster is attached to the plastic mesh base at the first edge and the second plastic mesh bolster is attached to the plastic mesh base at the first edge.

Clause 44. The vehicle seat cushion component of any of the preceding or successive clauses, wherein the vehicle seat cushion component is included in a vehicle seat back or a vehicle seat bottom.

Clause 45. The vehicle seat cushion component of any of the preceding or successive clauses, wherein the first plurality of three-dimensional filament loops, the second plurality of three-dimensional filament loops, and the third plurality of three-dimensional filament loops each independently include a plurality of fused connection in which two loops are attached to each other.

Clause 46. The vehicle seat cushion component of any of the preceding or successive clauses, wherein the first plurality of three-dimensional filament loops and the second plurality of three-dimensional filament loops are each independently shaped into a form for a vehicle seat bolster.

Clause 47. The vehicle seat cushion component of any of the preceding or successive clauses, wherein the first plastic mesh bolster and the second plastic mesh bolster are each disposed over the first face.

Clause 48. The vehicle seat cushion component of any of the preceding or successive clauses, wherein the first plastic mesh bolster is attached to the first edge and the second plastic mesh bolster is attached to the second edge.

Clause 49. The vehicle seat cushion component of any of the preceding or successive clauses, wherein the first plastic mesh bolster and the second plastic mesh bolster are attached to the plastic mesh base by hook and loop strips, an adhesive, a retention clip, and/or a hog ring.

Clause 50. The vehicle seat cushion component of any of the preceding or successive clauses, wherein at least a subset of loops in the first plurality of three-dimensional filament loops, at least a subset of loops in the second plurality of three-dimensional filament loops, and at least a subset of loops in the third plurality of three-dimensional filament loops are not parallel or aligned with each other.

Clause 51. The vehicle seat cushion component of any of the preceding or successive clauses, wherein at least a subset of loops in the first plurality of three-dimensional filament loops, at least a subset of loops in the second plurality of three-dimensional filament loops, and at least a subset of loops in the third plurality of three-dimensional filament loops are randomly oriented.

Clause 52. The vehicle seat cushion component of any of the preceding or successive clauses, a first skin layer is disposed over the first face of the plastic mesh base.

Clause 53. The vehicle seat cushion component of any of the preceding or successive clauses, a first skin layer is disposed over the second face of the plastic mesh base.

Clause 54. The vehicle seat cushion component of any of the preceding or successive clauses, wherein the first plastic mesh bolster, the first plastic mesh bolster, and the plastic mesh base independently include from 60 to 95 volume percent air.

Clause 55. The vehicle seat cushion component of any of the preceding or successive clauses, wherein the first plastic mesh bolster, the first plastic mesh bolster, and the plastic mesh base independently have a density from about 0.01 to 0.200 g/cm³.

Clause 56. The vehicle seat cushion component of any of the preceding or successive clauses, wherein the first thermoplastic polymer, the second thermoplastic polymer, and the third thermoplastic polymer are each independently an extruded thermoplastic polymer.

Clause 57. The vehicle seat cushion component of any of the preceding or successive clauses, wherein the first thermoplastic polymer, the second thermoplastic polymer, and the third thermoplastic polymer are each independently composed of a component selected from the group consisting of polyolefin, polystyrene-based thermoplastic elastomer, polyester-based thermoplastic elastomer, polyurethane-based thermoplastic elastomer, and polyamide-based thermoplastic elastomer.

Clause 58. The vehicle seat cushion component of any of the preceding or successive clauses, wherein the first thermoplastic polymer, the second thermoplastic polymer, and the third thermoplastic polymer are each independently a linear low-density polyethylene.

Clause 59. The vehicle seat cushion component of any of the preceding or successive clauses, wherein the first plurality of three-dimensional filament loops, the second plurality of three-dimensional filament loops, and the third plurality of three-dimensional filament loops have a fineness from 200 to 10000 decitex.

Clause 60. A vehicle seat cushion component in combination with, or without, any of the preceding or successive clauses, comprising: a first plastic mesh bolster including a first plurality of three-dimensional filament loops composed of a first thermoplastic polymer; a second plastic mesh bolster including a second plurality of three-dimensional filament loops composed of a second thermoplastic polymer; and a plastic mesh base including a third plurality of three-dimensional filament loops composed of a third thermoplastic polymer, the plastic mesh base having a first edge, a second edge, a first face, and a second face, wherein the first plastic mesh bolster is attached to the plastic mesh base at the first edge and the second plastic mesh bolster is attached to the plastic mesh base at the first edge, wherein the first plurality of three-dimensional filament loops, the second plurality of three-dimensional filament loops, and the third plurality of three-dimensional filament loops each independently include a plurality of fused connections in which two loops are attached to each other.

Clause 61. The vehicle seat cushion component of any of the preceding or successive clauses, wherein the vehicle seat cushion component is included in a vehicle seat back or a vehicle seat bottom.

Clause 62. The vehicle seat cushion component of any of the preceding or successive clauses, wherein the plastic mesh base is from 60 to 95 volume percent air.

Clause 63. The vehicle seat cushion component of any of the preceding or successive clauses, wherein the first thermoplastic polymer, the second thermoplastic polymer, and the third thermoplastic polymer are each independently composed of a component selected from the group consisting of polyolefin, polystyrene-based thermoplastic elastomer, polyester-based thermoplastic elastomer, polyurethane-based thermoplastic elastomer, and polyamide-based thermoplastic elastomer.

Clause 64. A vehicle seat cushion component, in combination with, or without, any of the preceding or successive clauses, comprising: a first bolster assembly including a first core cushion section surrounded by a first outer bolster covering which is surrounded by a first bolster trim covering; a second bolster assembly including a second core cushion section surrounded by a second outer bolster covering; and a trim covering section having a first edge and a second edge, the first bolster assembly being sewn to the trim covering section at the first edge and the second bolster assembly being sewn to the trim covering section at the second edge.

Clause 65. The vehicle seat cushion component of any of the preceding or successive clauses, wherein the vehicle seat cushion component is included in a vehicle seat back or a vehicle seat bottom.

Clause 66. The vehicle seat cushion component of any of the preceding or successive clauses, wherein the first bolster assembly and the second bolster assembly are each independently formed by compression molding.

Clause 67. The vehicle seat cushion component of any of the preceding or successive clauses, wherein the first outer bolster covering and the second outer bolster covering each independently includes a non-woven fabric.

Clause 68. The vehicle seat cushion component of any of the preceding or successive clauses, wherein the first outer bolster covering and the second outer bolster covering each independently include natural fibers.

Clause 69. The vehicle seat cushion component of any of the preceding or successive clauses further comprising a central cushion component positioned in an opening defined by the trim covering section.

Clause 70. The vehicle seat cushion component of any of the preceding or successive clauses, wherein the first core cushion section, the second core cushion section, and the central cushion component are each independently composed of a foamed polyurethane.

Clause 71. The vehicle seat cushion component of any of the preceding or successive clauses, wherein the first core cushion section, the second core cushion section, and the central cushion component are each independently composed of a plurality of three-dimensional filament loops composed of a thermoplastic polymer.

Clause 72. The vehicle seat cushion component of any of the preceding or successive clauses, wherein the plurality of three-dimensional filament loops includes a plurality of fused connections in which two loops are attached to each other.

Clause 73. The vehicle seat cushion component of any of the preceding or successive clauses, wherein at least a subset of loops in the plurality of three-dimensional filament loops are not parallel or aligned with each other.

Clause 74. The vehicle seat cushion component of any of the preceding or successive clauses, wherein the first core cushion section, the second core cushion section, and the central cushion component are independently from 60 to 95 volume percent air.

Clause 75. The vehicle seat cushion component of any of the preceding or successive clauses, wherein the first core cushion section, the second core cushion section, and the central cushion component each independently have a density from about 0.01 to 0.200 g/cm³.

Clause 76. The vehicle seat cushion component of any of the preceding or successive clauses, wherein the thermoplastic polymer is an extruded thermoplastic polymer.

Clause 77. The vehicle seat cushion component of any of the preceding or successive clauses, wherein the thermoplastic polymer is composed of a component selected from the group consisting of polyolefins, polystyrene-based thermoplastic elastomers, polyester-based thermoplastic elastomers, polyurethane-based thermoplastic elastomers, and polyamide-based thermoplastic elastomers.

Clause 78. The vehicle seat cushion component of any of the preceding or successive clauses, wherein the thermoplastic polymer is a biodegradable or recyclable polymer.

Clause 79. The vehicle seat cushion component of any of the preceding or successive clauses, wherein the plurality of three-dimensional filament loops has a fineness from 200 to 10000 decitex.

Clause 80. The vehicle seat cushion component of any of the preceding or successive clauses further comprising providing sound deadening and temperature buffering.

Clause 81. A vehicle seat in combination with, or without, any of the preceding or successive clauses, comprising: a seat bottom having a seat bottom frame; a seat back attached to the seat bottom, the seat back including a seat back frame; and a vehicle seat cushion component attached to the seat bottom frame and/or the seat back frame, the vehicle seat cushion component comprising: a first bolster assembly including a first core cushion section surrounded by a first outer bolster covering which is surrounded by a first bolster trim covering; a second bolster assembly including a second core cushion section surrounded by a second outer bolster covering which is surrounded by a second bolster trim covering; and a trim covering section having a first edge and a second edge, the first bolster assembly being sewn to the trim covering section at the first edge and the second bolster assembly being sewn to the trim covering section at the second edge.

Clause 82. The vehicle seat of any of the preceding or successive clauses, wherein the first outer bolster covering and the second outer bolster covering each independently includes a non-woven fabric.

Clause 83. The vehicle seat of any of the preceding or successive clauses, wherein the first outer bolster covering and the second outer bolster covering each independently include natural fibers.

Clause 84. The vehicle seat of any of the preceding or successive clauses, wherein the vehicle seat cushion component further includes a central cushion component positioned in an opening defined by the trim covering section.

Clause 85. The vehicle seat of any of the preceding or successive clauses, wherein the first core cushion section, the second core cushion section, and the central cushion component are each independently composed of a foamed polyurethane.

Clause 86. The vehicle seat of any of the preceding or successive clauses, wherein the first core cushion section, the second core cushion section, and the central cushion component are each independently composed of a plurality of three-dimensional filament loops composed of a thermoplastic polymer.

Clause 87. The vehicle seat of any of the preceding or successive clauses, wherein the plurality of three-dimensional filament loops includes a plurality of fused connection in which two loops are attached to each other.

Clause 88. The vehicle seat of any of the preceding or successive clauses, wherein at least a subset of loops in the plurality of three-dimensional filament loops are not parallel or aligned with each other.

Clause 89. The vehicle seat of any of the preceding or successive clauses, wherein the first core cushion section and the second core cushion section are from 60 to 95 volume percent air.

Clause 90. The vehicle seat of any of the preceding or successive clauses, wherein the first core cushion section and the second core cushion section each independently a density from about 0.01 to 0.200 g/cm³.

Clause 91. The vehicle seat of any of the preceding or successive clauses, wherein the thermoplastic polymer is an extruded thermoplastic polymer.

Clause 92. A vehicle seat cushion component in combination with, or without, any of the preceding or successive clauses, comprising: a plastic mesh base, the plastic mesh base comprising a plurality of three-dimensional filament loops, the three-dimensional filament loops composed of a thermoplastic polymer, the plastic mesh base having a first edge, a second edge, a first face, and a second face; a first foamed bolster attached to the plastic mesh base at the first edge; and a second foamed bolster attached to the plastic mesh base at the second edge.

Clause 93. The vehicle seat cushion component of any of the preceding or successive clauses, wherein the vehicle seat cushion component is included in a vehicle seat back or a vehicle seat bottom.

Clause 94. The vehicle seat cushion component of any of the preceding or successive clauses, wherein the plurality of three-dimensional filament loops includes a plurality of fused connections in which two loops are attached to each other.

Clause 95. The vehicle seat cushion component of any of the preceding or successive clauses, wherein the first foamed bolster and the second foamed bolster are each independently composed of a foamed polymer.

Clause 96. The vehicle seat cushion component of any of the preceding or successive clauses, wherein the first foamed bolster and the second foamed bolster are each independently composed of a foamed polyurethane.

Clause 97. The vehicle seat cushion component of any of the preceding or successive clauses, wherein the first foamed bolster and the second foamed bolster are each at least partially disposed over the first face.

Clause 98. The vehicle seat cushion component of any of the preceding or successive clauses, wherein the first foamed bolster is attached to the first edge and the second foamed bolster is attached to the second edge.

Clause 99. The vehicle seat cushion component of any of the preceding or successive clauses, wherein the first foamed bolster is attached to the plastic mesh base with a first retention clip and the first foamed bolster is attached to the plastic mesh base with a second retention clip, the first retention clip and the second retention clip each having an end embedded in the foam of the respective, first or second foamed bolster, and a retention clip end attached to the plastic mesh base.

Clause 100. The vehicle seat cushion component of any of the preceding or successive clauses, wherein at least a subset of loops in the plurality of three-dimensional filament loops are not parallel or aligned with each other.

Clause 101. The vehicle seat cushion component of any of the preceding or successive clauses, wherein loops in the plurality of three-dimensional filament loops are randomly oriented.

Clause 102. The vehicle seat cushion component of any of the preceding or successive clauses, wherein the plastic mesh base is from 60 to 95 volume percent air.

Clause 103. The vehicle seat cushion component of any of the preceding or successive clauses, wherein the plastic mesh base has a density from about 0.01 to 0.200 g/cm³.

Clause 104. The vehicle seat cushion component of any of the preceding or successive clauses, wherein the thermoplastic polymer is an extruded thermoplastic polymer.

Clause 105. The vehicle seat cushion component of any of the preceding or successive clauses, wherein the thermoplastic polymer includes a component selected from the group consisting of polyolefins, polystyrene-based thermoplastic elastomers, polyester-based thermoplastic elastomers, polyurethane-based thermoplastic elastomers, and polyamide-based thermoplastic elastomers.

Clause 106. The vehicle seat cushion component of any of the preceding or successive clauses, wherein the thermoplastic polymer includes linear low-density polyethylene.

Clause 107. The vehicle seat cushion component of any of the preceding or successive clauses, wherein the plurality of three-dimensional filament loops has a fineness from 200 to 10000 decitex.

Clause 108. A vehicle seat cushion component in combination with, or without, any of the preceding or successive clauses, comprising: a plastic mesh base, the plastic mesh base comprising a plurality of three-dimensional filament loops, the three-dimensional filament loops composed of a thermoplastic polymer.

Clause 109. The vehicle seat cushion component of any of the preceding or successive clauses, wherein the vehicle seat cushion component is included in a vehicle seat back or a vehicle seat bottom.

Clause 110. The vehicle seat cushion component of any of the preceding or successive clauses, wherein the plurality of three-dimensional filament loops includes a plurality of fused connections in which two loops are attached to each other.

Clause 111. The vehicle seat cushion component of any of the preceding or successive clauses, wherein loops in the plurality of three-dimensional filament loops are randomly oriented.

Clause 112. The vehicle seat cushion component of any of the preceding or successive clauses, wherein the plastic mesh base is from 60 to 95 volume percent air.

Clause 113. The vehicle seat cushion component of any of the preceding or successive clauses, wherein the thermoplastic polymer includes a component selected from the group consisting of polyolefins, polystyrene-based thermoplastic elastomers, polyester-based thermoplastic elastomers, polyurethane-based thermoplastic elastomers, and polyamide-based thermoplastic elastomers.

Clause 114. An assembly in combination with, or without, any of the preceding or successive clauses, comprising: at least one fabric sized to be displaced across a surface of a cushion; and at least one retainer coupled to the at least one fabric, along a perimeter of the fabric, to receive a trim component, an actuator, a heat transfer layer, or any combination thereof.

Clause 115. The assembly of any of the preceding or successive clauses, further comprising the cushion.

Clause 116. The assembly of any of the preceding or successive clauses, wherein the cushion further comprises a stranded-mesh material.

Clause 117. The assembly of any of the preceding or successive clauses, further comprising a trim cover sized to at least partially enclose the cushion and the at least one fabric, wherein the trim cover is coupled to the at least one retainer.

Clause 118. The assembly of any of the preceding or successive clauses, wherein the at least one retainer comprises at least one clamped ring.

Clause 119. The assembly of any of the preceding or successive clauses, wherein the at least one retainer is not directly coupled to the cushion.

Clause 120. The assembly of any of the preceding or successive clauses, wherein the at least one fabric further comprises a non-woven material.

Clause 121. The assembly of any of the preceding or successive clauses, wherein the non-woven material further comprises jute.

Clause 122. A seat assembly comprising: a seat bottom; a seat back; and the seat trim assembly of any of any of the preceding or successive clauses, in the seat bottom or the seat back.

Clause 123. A product formed by a method in combination with, or without, any of the preceding or successive clauses, comprising: coupling at least one retainer to a perimeter of at least one fabric; stacking the at least one fabric upon a cushion; and coupling a trim component, an actuator, a heat transfer layer, or any combination thereof to the at least one retainer.

Clause 124. The product formed by the method of any of the preceding or successive clauses, the method further comprising compression molding the at least one fabric to a contour of a cushion before stacking the at least one fabric upon the cushion.

Clause 125. The product formed by the method of any of the preceding or successive clauses, the method further comprising coupling a trim cover sized to at least partially enclose the cushion and the at least one fabric, to the at least one retainer.

Clause 126. The product of any of the preceding or successive clauses, wherein stacking the at least one fabric upon the cushion further comprises stacking the at least one fabric upon a stranded-mesh material cushion.

Clause 127. The product formed by the method of any of the preceding or successive clauses, the method further comprising not directly coupling the at least one retainer to the cushion.

Clause 128. The product formed by the method of any of the preceding or successive clauses, wherein further comprising clamping at least one clamped ring to the fabric as the at least one retainer.

Clause 129. A seat assembly comprising: a seat bottom; a seat back; and the product of any of any of the preceding or successive clauses, in the seat bottom or the seat back.

Clause 130. A method in combination with, or without, any of the preceding or successive clauses, comprising: coupling at least one retainer to a perimeter of at least one fabric; stacking the at least one fabric upon a cushion; and coupling a trim component, an actuator, a heat transfer layer, or any combination thereof to the at least one retainer.

Clause 131. The method of any of the preceding or successive clauses, further comprising at least partially enclosing the cushion and the at least one fabric by coupling a trim cover to the at least one retainer.

Clause 132. The method of any of the preceding or successive clauses, wherein the at least one fabric further comprises a non-woven material.

Clause 133. A trim assembly manufactured from the method of any of the preceding or successive clauses.

Clause 134. A cushion in combination with, or without, any of the preceding or successive clauses, comprising: a member comprising a stranded mesh material, the member defining a first end region and a second end region, the first and second end regions bounded by an outer perimeter of the member; and wherein the first end region is positioned at a nonzero angle relative to the second end region.

Clause 135. The cushion of any of the preceding or successive clauses wherein the member is formed solely from the stranded mesh material.

Clause 136. The cushion of any of the preceding or successive clauses wherein the stranded mesh material comprises a polymeric mesh having a plurality of integrated polymeric strands.

Clause 137. The cushion of any of the preceding or successive clauses wherein the first end region is shaped to define a seat back cushion; and wherein the second end region is shaped to define a seat base cushion.

Clause 138. The cushion of any of the preceding or successive clauses wherein the member further comprises a first surface to support an occupant on the cushion and a second surface opposite to the first surface, the first surface extending across the first and second end regions, the second surface extending across the first and second end regions.

Clause 139. The cushion of any of the preceding or successive clauses wherein the member defines one or more channels, each channel intersecting one of the first surface and the second surface.

Clause 140. The cushion of any of the preceding or successive clauses wherein the channel extends transversely across the member and is positioned between the first end region and the second end region.

Clause 141. The cushion of any of the preceding or successive clauses wherein the channel comprises a first face and a second face, wherein the first and second faces are mated with one another.

Clause 142. The cushion of any of the preceding or successive clauses further comprising one or more channel fasteners connecting the first face to the second face to retain the first end region at the nonzero angle relative to the second end region.

Clause 143. The cushion of any of the preceding or successive clauses further comprising one or more secondary members supported by the member.

Clause 144. The cushion of any of the preceding or successive clauses wherein the secondary member comprises a stranded mesh material.

Clause 145. The cushion of any of the preceding or successive clauses wherein the secondary member extends outwardly from at least one of the first end region and the second end region of the member.

Clause 146. The cushion of any of the preceding or successive clauses further comprising one or more secondary member fasteners connecting the secondary member to the member.

Clause 147. The cushion of any of the preceding or successive clauses wherein the secondary member is shaped and positioned on the member to form a side bolster or a lumbar pad.

Clause 148. A seat assembly comprising: a frame; and the cushion according to any of the preceding or successive clauses, the cushion supported by the frame.

Clause 149. A tool comprising: a die defining a series of apertures arranged to extrude material for the stranded mesh material member for the cushion according to any of the preceding or successive clauses, the series of apertures arranged to define the outer perimeter of the member containing a seat back region and a seat base region.

Clause 150. The tool of any of the preceding or successive clauses wherein the series of apertures are further arranged such that the outer perimeter defines one or more channels for the member.

Clause 151. The tool of any of the preceding or successive clauses wherein the series of apertures are arranged such that the one or more channels are positioned between the seat back region and the seat base region.

Clause 152. A method in combination with, or without, any of the preceding or successive clauses, comprising: positioning a first end region of a stranded mesh material member at a nonzero angle relative to a second end region of the member; and retaining the first end region relative to the second end region at the nonzero angle.

Clause 153. The method of any of the preceding or successive clauses further comprising forming the stranded mesh material member by extruding material through a die.

Clause 154. The method of any of the preceding or successive clauses wherein the stranded mesh material member is extruded to form the first end region and the second end region.

Clause 155. The method of any of the preceding or successive clauses wherein forming the stranded mesh material member further comprises funneling the extruded material from the die through a funnel.

Clause 156. The method of any of the preceding or successive clauses further comprising moving the extruded material after the funnel via one or more rollers.

Clause 157. The method of any of the preceding or successive clauses further comprising forming one or more channels during at least one of extruding the material, funneling the extruded material, and moving the extruded material.

Clause 158. The method of any of the preceding or successive clauses further comprising cutting the one or more channels into the member.

Clause 159. The method of any of the preceding or successive clauses further comprising inserting one or more fasteners into opposed sides of the channel and/or bonding the opposed sides of the channel to retain the first end region relative to the second end region.

Clause 160. The method of any of the preceding or successive clauses further comprising cutting the extruded material to form an outer surface of the member, the outer surface extending across the first and second end regions.

Clause 161. The method of any of the preceding or successive clauses further comprising bending the stranded mesh material member from a first position to a second position to orient the member.

Clause 162. The method of any of the preceding or successive clauses further comprising attaching one or more secondary members to the member.

Clause 163. The method of any of the preceding or successive clauses further comprising forming the secondary member from a stranded mesh material.

Clause 164. The method of any of the preceding or successive clauses wherein attaching the secondary member to the member further comprises inserting one or more fasteners into the secondary member and the member and/or bonding the secondary member to the member.

Clause 165. The method of any of the preceding or successive clauses further comprising attaching the member to a frame of a seat assembly to provide a cushion therefor.

Clause 166. Any of the preceding clauses 1-165 in any combination.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1-165. (canceled)

166. A seat support comprising a plurality of layers or regions of a plastic mesh, characterized in that the plurality of layers or regions is stacked upon each other, attached to each other, or positioned at a nonzero angle relative to each other.

167. The seat support of claim 166 further comprising:
a member comprising a stranded mesh material as the plastic mesh, the stranded mesh material member defining a first end region and a second end region, the first and second end regions bounded by an outer perimeter of the stranded mesh material member; and
wherein the first end region is positioned at a nonzero angle relative to the second end region.

168. The seat support of claim 167 wherein the stranded mesh material member is formed solely from the stranded mesh material.

169. The seat support of claim 168 wherein the stranded mesh material comprises a polymeric mesh having a plurality of integrated polymeric strands.

170. The seat support of claim 167 wherein the first end region is shaped to define a seat back cushion; and
wherein the second end region is shaped to define a seat base cushion.

171. The seat support of claim 167 wherein the stranded mesh material member further comprises a first surface to support an occupant on the seat support and a second surface opposite to the first surface, the first surface extending across the first and second end regions, the second surface extending across the first and second end regions.

172. The seat support of claim 171 wherein the stranded mesh material member defines one or more channels, each channel intersecting one of the first surface and the second surface.

173. The seat support of claim 172 wherein the one or more channels extends transversely across the stranded mesh material member and is positioned between the first end region and the second end region.

174. The seat support of claim 172 wherein the channel comprises a first face and a second face, wherein the first and second faces are mated with one another.

175. The seat support of claim 174 further comprising one or more channel fasteners connecting the first face to the second face to retain the first end region at the nonzero angle relative to the second end region.

176. The seat support of claim 167 further comprising a secondary member supported by the stranded mesh material member.

177. The seat support of claim 176 wherein the secondary member comprises a stranded mesh material.

178. The seat support of claim 176 wherein the secondary member extends outwardly from at least one of the first end region and the second end region of the stranded mesh material member.

179. The seat support of claim 176 further comprising one or more secondary member fasteners connecting the secondary member to the stranded mesh material member.

180. The seat support of claim 176 wherein the secondary member is shaped and positioned on the stranded mesh material member to form a side bolster or a lumbar pad.

181. The seat support of claim 166 further comprising a plurality of flat layers to mount to a seat frame and to support an occupant upon the seat frame, wherein the plurality of flat layers is stacked upon one another, and each of the plurality of stacked layers has a varying density.

182. The seat support of claim 166 further comprising:
a first bolster assembly including a first core cushion section surrounded by a first outer bolster covering which is surrounded by a first bolster trim covering;
a second bolster assembly including a second core cushion section surrounded by a second outer bolster covering; and
a trim covering section having a first edge and a second edge, the first bolster assembly being sewn to the trim covering section at the first edge and the second bolster assembly sewn to the trim covering section at the second edge.

183. The seat support of claim 166 further comprising a plastic mesh base, the plastic mesh base comprising a plurality of three-dimensional filament loops, the three-dimensional filament loops composed of a thermoplastic polymer, the plastic mesh base having a first edge, a second edge, a first face, and a second face, a first foamed bolster attached to the plastic mesh base at the first edge, and a second foamed bolster attached to the plastic mesh base at the second edge.

184. The seat support of claim 166 further comprising at least one fabric sized to be displaced across a surface of a cushion, and at least one retainer coupled to the at least one fabric, along a perimeter of the fabric, to receive a trim component, an actuator, a heat transfer layer, or any combination thereof.

185. A seat assembly comprising:
a seat bottom;
a seat back; and
the seat support of claim 166, in the seat bottom or the seat back.
